(19) United States
(12) Patent Application Publication
(10) Pub. No.: US 2021/0061355 A1
(43) Pub. Date: Mar. 4, 2021

(54) MEASUREMENT DEVICE

(71) Applicant: Panasonic Intellectual Property Management Co., Ltd., Osaka (JP)

(72) Inventor: Motoyuki OKAYAMA, Osaka (JP)

(73) Assignee: Panasonic Intellectual Property Management Co., Ltd., Osaka (JP)

(21) Appl. No.: 16/939,735

(22) Filed: Jul. 27, 2020

(30) Foreign Application Priority Data
Aug. 28, 2019 (JP) 2019-155995
Aug. 28, 2019 (JP) 2019-155999
Aug. 28, 2019 (JP) 2019-156012
Feb. 10, 2020 (JP) 2020-020413

(51) Int. Cl. B62D 15/02; B62D 1/04; G06F 3/044

(52) U.S. Cl. CPC B62D 15/029; G06F 3/0443; B62D 1/04

(57) ABSTRACT

A measurement device includes: a first cover electrode provided on a steering wheel; a second electrode (a second cover electrode or a first seat electrode) provided on a front surface section of a driver's seat or on the steering wheel; a grip detection circuit electrically connected to the first cover electrode via a first high pass filter; and an electrocardiographic detection circuit electrically connected to at least the first cover electrode via a first low pass filter and electrically connected to the second electrode.

### CROSS REFERENCE TO RELATED APPLICATIONS

The present application is based on and claims priority of: Japanese Patent Application No. 2019-155995 filed on Aug. 28, 2019; Japanese Patent Application No. 2019-155999 filed on Aug. 28, 2019; Japanese Patent Application No. 2019-156012 filed on Aug. 28, 2019; and Japanese Patent Application No. 2020-020413 filed on Feb. 10, 2020.

### FIELD

The present disclosure relates to a measurement device.

### BACKGROUND

A conventional electrocardiographic measuring device for a vehicle includes: a direct electrode that is disposed on the steering wheel of the vehicle and detects a body potential of the driver by contact with the driver's skin, a first capacitive coupling electrode and a second capacitive coupling electrode that are disposed on the backrest portion of a seat, and an electrocardiograph that measures an electrocardiogram of the driver based on a difference between (i) the potential difference between the body potential detected by the direct electrode and the body potential detected by the first capacitive coupling electrode and (ii) the potential difference between the body potential detected by the direct electrode and the body potential detected by the second capacitive coupling electrode (for example, see Patent Literature (PTL) 1).

### CITATION LIST

### Patent Literature

PTL 1: Japanese Unexamined Patent Application Publication No. 2013-212311

### SUMMARY

The above-described electrocardiographic measuring device for a vehicle according to PTL 1 can be improved upon.

In view of this, the present disclosure provides a measurement device capable of improving upon the above related art.

A measurement device according to one aspect of the present disclosure includes: a first electrode provided on a steering wheel; a second electrode provided on a front surface section of a driver's seat or on the steering wheel; a grip detection circuit electrically connected to the first electrode via a first high pass filter; and an electrocardiographic detection circuit electrically connected to at least the first electrode via a first low pass filter and electrically connected to the second electrode.

General or, specific aspects of the present disclosure may be realized as any given combination of a system, a method, and an integrated circuit and the like.

A measurement device according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 illustrates one example of the interior of a vehicle equipped with a measurement device according to Embodiment 1.

FIG. 2 schematically illustrates an example of a steering wheel cover and a driver's seat according to Embodiment 1.

FIG. 3A is a block diagram of the measurement device according to Embodiment 1.

FIG. 3B is a block diagram of a measurement device according to a variation of Embodiment 1.

FIG. 4 is a block diagram of a measurement device according to Embodiment 2.

FIG. 5 is a block diagram of a measurement device according to Embodiment 3.

FIG. 6 is a block diagram of a measurement device according to Embodiment 4.

FIG. 7 is a flow chart of processes performed by the measurement device according to Embodiment 4.

FIG. 8 is a block diagram of a measurement device according to a variation of Embodiment 4.

FIG. 9 is a block diagram of a measurement device according to Embodiment 5.

FIG. 10 is a block diagram of a measurement device according to Embodiment 6.

FIG. 11A is a block diagram of a measurement device according to Embodiment 7.

FIG. 11B schematically illustrates a first selector and switches included in the measurement device according to Embodiment 7.

FIG. 12 is a flow chart of processes performed by the measurement device according to Embodiment 7.

FIG. 13 is a block diagram of a measurement device according to Embodiment 8.

FIG. 14 is a flow chart of processes performed by the measurement device according to Embodiment 8.

FIG. 15 is a block diagram of a measurement device according to a variation of Embodiment 8.

FIG. 16 is a block diagram of a measurement device according to Embodiment 9.

FIG. 17 is a flow chart of processes performed by the measurement device according to Embodiment 9.

FIG. 18 is a block diagram of a measurement device according to Embodiment 10.

FIG. 19 is a block diagram of a measurement device according to another variation.

FIG. 20 is a block diagram of a measurement device according to another variation.

FIG. 21 is a block diagram of a measurement device according to another variation.

### DESCRIPTION OF EMBODIMENTS

With the conventional electrocardiographic measuring device for a vehicle, if the gripping of the steering wheel is desired to be detected, a grip sensor is provided on the outer circumferential surface of the steering wheel. In such cases, an electrocardiographic sensor electrode is provided in one region of the outer circumferential surface of the steering wheel, and a grip sensor electrode is disposed in another region of the outer circumferential surface of the steering wheel. However, when this configuration is used, there is a region of the steering wheel in which grip of the steering wheel cannot be detected, and there is another region of the steering wheel in which an electrocardiogram (ECG) waveform cannot be detected. In other words, both the grip detection and the ECG waveform detection have dead regions on the outer circumferential surface of the steering wheel, which reduces detection accuracy. One conceivable configuration to overcome this is to layer the grip sensor electrode and the electrocardiographic sensor electrode so as to overlap on the outer circumferential surface of the steering wheel. However, such a configuration reduces the sensitivity of the electrode that is disposed below the other electrode, which ultimately reduces detection accuracy.

In view of this, a measurement device according to one aspect of the present disclosure includes: a first electrode provided on a steering wheel; a second electrode provided on a front surface section of a driver's seat or on the steering wheel; a grip detection circuit electrically connected to the first electrode via a first high pass filter; and an electrocardiographic detection circuit electrically connected to at least the first electrode via a first low pass filter and electrically connected to the second electrode.

Typically, the frequency of the detection signal indicating an ECG waveform is lower than the frequency of the detection signal indicating a grip. In the present disclosure, in a state in which the driver is sitting in the driver's seat and gripping the steering wheel, the detection signal from the first electrode is input into the grip detection circuit via the first high pass filter and input into the electrocardiographic detection circuit via the first low pass filter, and the detection signal from the second electrode is also input into the electrocardiographic detection circuit. Accordingly, the grip detection circuit can perform grip detection based on changes in electrostatic capacitance between the first electrode and the driver's hand, from the detection signal input via the first high pass filter. Moreover, the electrocardiographic detection circuit can detect the ECG waveform of the driver from the potential difference between the potential of the first electrode and the potential of the second electrode. Accordingly, the presence of dead regions in the grip detection and ECG waveform detection, and a reduction in electrode sensitivity, like is seen with conventional techniques, are less likely to occur.

Accordingly, the accuracy of the grip detection and the ECG waveform detection can be inhibited from decreasing.

In particular, as a result of each of the first electrode and the second electrode being used commonly as both an electrode for the grip detection and an electrode for the ECG waveform detection, the same electrode can be used to perform the grip detection and the ECG waveform detection. Accordingly, cases in which there is a region of the steering wheel in which grip of the steering wheel cannot be detected, and there is another region of the steering wheel in which an ECG waveform cannot be detected, that is to say, cases in which both the grip detection and the ECG waveform detection have dead regions, are unlikely. Consequently, grip detection and ECG waveform detection can be performed with certainty.

Moreover, with this measurement device, since grip detection and ECG waveform detection need not be performed using respective electrodes, the manufacturing cost of the measurement device can be inhibited from steeply increasing.

Moreover, with the measurement device, since an electrode for ECG waveform detection and an electrode for grip detection need not be wrapped around the rim, the steering wheel can be inhibited from being difficult to grip due to an increase in the thickness of the steering wheel cover.

Moreover, in the measurement device according to another aspect of the present disclosure, the second electrode is: provided in a different location on the steering wheel than the first electrode; electrically connected to the grip detection circuit via a second high pass filter different from the first high pass filter; and electrically connected to the electrocardiographic detection circuit via a second low pass filter different from the first low pass filter.

With this configuration, since providing the first electrode and the second electrode on the steering wheel allows for both grip detection and ECG waveform detection to be performed, the installment of the measurement device is simplified.

Moreover, in the measurement device according to another aspect of the present disclosure, the grip detection circuit outputs, independently of each other, a signal indicating a detection result according to a detection signal resulting from detection by the first electrode and a signal indicating a detection result according to a detection signal resulting from detection by the second electrode.

This configuration makes it possible to determine whether the driver is gripping the steering wheel with both hands or not. For example, by determining whether the driver is appropriately gripping the steering wheel with both hands when control of the vehicle is handed over to the driver from a semiautonomous or autonomous driving state, the driver can be, for example, alerted to the grip steering wheel with both hands in order to improve the safety of the driver driving the vehicle.

Moreover, in the measurement device according to another aspect of the present disclosure, the second electrode is provided on the front surface section.

This configuration makes it possible to utilize a part of the body that is characterized by a conductive path through the body—from the hand of the driver to the thigh of the driver—that is longer than the conductive path from the left hand of the driver to the right hand of the driver. In other words, the potential difference between the potential of the first electrode that detects one hand of the driver and the potential of the second electrode that detects the thigh of driver is greater than the potential difference between the potential of the first electrode when configured to detect the right hand of the driver and the potential of the second electrode when configured to detect the left hand of the driver. Consequently, with the measurement device according to the present disclosure, an ECG waveform can be measured more accurately.

Moreover, the measurement device according to another aspect of the present disclosure further includes a third electrode provided in a different location on the steering wheel than the first electrode. The third electrode is electrically connected to the grip detection circuit via a second high pass filter different from the first high pass filter.

With this configuration, since it is possible to determine whether the driver is gripping the steering wheel with both hands, the driver can be, for example, alerted to grip the steering wheel with both hands in order to improve the safety of the driver driving the vehicle.

Moreover, since the measurement device includes the first electrode as well, the potential difference between the first electrode or the third electrode that detects one hand and the second electrode that detects the thigh can be measured. Accordingly, the measurement device can measure an ECG waveform more accurately. In other words, the measurement device can improve the accuracy of grip detection and ECG waveform detection performed using both hands.

Moreover, in the measurement device according to another aspect of the present disclosure, the grip detection circuit outputs, independently of each other, a signal indicating a detection result according to a detection signal resulting from detection by the first electrode and a signal indicating a detection result according to a detection signal resulting from detection by the third electrode.

As described above, this configuration makes it possible to determine whether the driver is gripping the steering wheel with both hands or not. Accordingly, with this measurement device, the safety of the driver driving the vehicle can be further increased.

Moreover, the measurement device according to another aspect of the present disclosure further includes: a fourth electrode provided on the front surface section in a different location than the second electrode; a first low pass filter electrically connected to the first electrode; a second low pass filter electrically connected to the third electrode, the second low pass filter being different from the first low pass filter; a multiplexer provided between (i) the electrocardiographic detection circuit and (ii) the first low pass filter, the second low pass filter, the second electrode, and the fourth electrode, the multiplexer being electrically connected to the electrocardiographic detection circuit, the first low pass filter, the second low pass filter, the second electrode, and the fourth electrode; and a control circuit electrically connected to the multiplexer. The electrocardiographic detection circuit includes an amplification circuit electrically connected to the multiplexer. The control circuit switches the multiplexer so as to cause the electrocardiographic detection circuit to output a signal indicating detection results according to two of the four detection signals from the first electrode, the second electrode, the third electrode, and the fourth electrode.

With this configuration, the control circuit can cause the multiplexer to extract two of the four detection signals from the first electrode, the second electrode, the third electrode, and the fourth electrode by switching the multiplexer. Stated differently, since the control circuit can arbitrarily select two of the four electrodes, this measurement device can perform grip detection and ECG waveform detection suited to the driver's posture, for example.

Moreover, the measurement device according to another aspect of the present disclosure further includes: a fourth electrode provided on the front surface section in a different location than the second electrode; a first low pass filter electrically connected to the first electrode; a second low pass filter electrically connected to the third electrode, the second low pass filter being different from the first low pass filter; and a control circuit electrically connected to the electrocardiographic detection circuit. The electrocardiographic detection circuit includes: a first amplification circuit that is electrically connected to at least one of the first low pass filter and the second low pass filter and electrically connected to the second electrode; a second amplification circuit that is electrically connected to at least one of the first low pass filter and the second low pass filter or the fourth electrode, and electrically connected to the second electrode; and a multiplexer electrically connected to output sides of each of the first amplification circuit and the second amplification circuit. The control circuit switches the multiplexer so that (i) one of the first electrode, the third electrode, and the fourth electrode and (ii) the electrocardiographic detection circuit are electrically connected.

With this configuration, as a result of the control circuit switching the multiplexer, it is possible to select a given potential difference from among three potential differences—namely the potential difference between the potential of the first electrode and the potential of the second electrode, the potential difference between the potential of the third electrode and the potential of the second electrode, and the potential difference between the potential of the fourth electrode and the potential of the second electrode. In other words, the control circuit can cause the multiplexer to extract one amplification signal from among the amplification signals output from the amplification circuits. As a result, the control circuit can select an appropriate amplification signal from among a plurality of amplification signals, whereby the measurement device can further improve the accuracy of the grip detection and the ECG waveform detection.

Moreover, in the measurement device according to another aspect of the present disclosure, the control circuit: is connected to the electrocardiographic detection circuit; sequentially switches the multiplexer so as to sequentially select all possible combinations of electrical connections between (i) any two of the first electrode, the second electrode, the third electrode, and the fourth electrode and (ii) the electrocardiographic detection circuit; and controls the multiplexer so as to output a combination of detection signals from the two electrodes whose detection signals exhibit the greatest output width, from among all the combinations of two electrodes.

With this configuration, by extracting, from among the four detection signals from the four electrodes—the first electrode, the second electrode, the third electrode, and the fourth electrode—an optimal combination of two detection signals, that is, the combination that has the greatest output width, the control circuit can select the combination of the two electrodes that correspond to the two extracted detection signals. In other words, the control circuit can select the combination of the two electrodes that have the greatest potential difference. Accordingly, with this measurement device, the accuracy of the ECG waveform detection can be increased with more certainty.

Moreover, in the measurement device according to another aspect of the present disclosure, the third electrode is electrically connected to the electrocardiographic detection circuit via the second low pass filter, and an output of the first low pass filter and an output of the second low pass filter are combined and input into the electrocardiographic detection circuit.

With this configuration, the detection signal from the first electrode and the detection signal from the third electrode are combined and input into the electrocardiographic detection circuit. Accordingly, the first electrode and the third electrode behave as a single electrode. This increases the surface area of the electrodes that oppose the hands of the driver, which increases the accuracy of the ECG waveform detection with more certainty.

Moreover, the measurement device according to another aspect of the present disclosure further includes a voltage follower circuit electrically connected to the first low pass filter and the electrocardiographic detection circuit. A wiring distance from the first low pass filter to the first electrode is shorter than a wiring distance from the first low pass filter to the electrocardiographic detection circuit, and a wiring distance from the voltage follower circuit to the first electrode is shorter than a wiring distance from the voltage follower circuit to the electrocardiographic detection circuit.

With this configuration, on the wiring path from the first electrode to the electrocardiographic detection circuit and on the wiring path from the second electrode or the third electrode to the electrocardiographic detection circuit, the first low pass filter and the voltage follower circuits are disposed closer to the electrodes than to the electrocardiographic detection circuit. Among the wiring path from the first electrode to the electrocardiographic detection circuit and the wiring path from the second electrode or the third electrode to the electrocardiographic detection circuit, the voltage follower circuits can convert the output impedance of the wiring paths to the electrocardiographic detection circuit to a low impedance. Accordingly, with this measurement device, it is possible to inhibit the influence of noise on the wiring paths between the voltage follower circuits and the electrocardiographic detection circuit.

The measurement device according to another aspect of the present disclosure further includes a first selector electrically connected to the first electrode, the first low pass filter, and the first high pass filter. The electrocardiographic detection circuit is electrically connected to the first electrode via the first low pass filter, and electrically connected to the second electrode. The first selector is configured to select the first low pass filter and configured to select the first high pass filter.

Typically, the frequency of the detection signal indicating an ECG waveform is lower than the frequency of the detection signal indicating a grip. With the present disclosure, in a state in which the driver is sitting in the driver's seat and gripping the steering wheel, as a result of the first selector being configured to select the first low pass filter and configured to select the first high pass filter, there are instances in which the detection signal from the first electrode is input into the grip detection circuit via the first high pass filter, there are instances in which the detection signal from the second electrode is input into the electrocardiographic detection circuit, and there are instances in which the detection signal from the first electrode is input into the electrocardiographic detection circuit via the first low pass filter. Accordingly, the grip detection circuit can perform grip detection based on changes in electrostatic capacitance between the first electrode and the driver's hand, from the detection signal input via the first high pass filter. Moreover, the electrocardiographic detection circuit can detect the ECG waveform of the driver from the potential difference between the potential of the first electrode and the potential of the second electrode. Accordingly, the presence of dead regions in the grip detection and ECG waveform detection, and a reduction in electrode sensitivity, like is seen with conventional techniques, are less likely to occur.

Accordingly, the accuracy of the grip detection and the ECG waveform detection can be inhibited from decreasing.

In particular, the first electrode does not concurrently connect to the first low pass filter and the first high pass filter via the first selector, that is to say, the grip detection circuit and the electrocardiographic detection circuit are not concurrently connected. Accordingly, noise superimposed on the electrocardiographic detection circuit is blocked by the first selector, inhibiting propagation to the grip detection circuit. Accordingly, with this measurement device, the accuracy of the grip detection by the grip detection circuit can be increased.

Moreover, as a result of each of the first electrode and the second electrode being used commonly as both an electrode for the grip detection and an electrode for the ECG waveform detection, the same electrode can be used to perform the grip detection and the ECG waveform detection. Accordingly, cases in which there is a region of the steering wheel in which grip of the steering wheel cannot be detected, and there is another region of the steering wheel in which an ECG waveform cannot be detected, that is to say, cases in which both the grip detection and the ECG waveform detection have dead regions, are unlikely. Consequently, grip detection and ECG waveform detection can be performed with certainty.

Moreover, with this measurement device, since grip detection and ECG waveform detection need not be performed using respective electrodes, the manufacturing cost of the measurement device can be inhibited from steeply increasing and the structure of the measurement device can be kept from becoming overly complicated.

Moreover, with the measurement device, since an electrode for ECG waveform detection and an electrode for grip detection need not be wrapped around the rim, the steering wheel can be inhibited from being difficult to grip due to an increase in the thickness of the steering wheel cover.

Moreover, the measurement device according to another aspect of the present disclosure further includes: a second selector electrically connected to the second electrode; a second low pass filter electrically connected to the second selector, the second low pass filter being different from the first low pass filter; and a second high pass filter electrically connected to the second selector, the second high pass filter being different from the first high pass filter. The electrocardiographic detection circuit is electrically connected to the first low pass filter and the second low pass filter. The grip detection circuit is electrically connected to the first high pass filter and the second high pass filter. The second electrode is provided in a different location on the steering wheel than the first electrode. The second selector is configured to select the second low pass filter, and configured to select the second high pass filter, in synchronization with the first selector.

With this configuration, in a state in which the driver is sitting in the driver's seat and gripping the steering wheel, as a result of the second selector being configured to select the second low pass filter and configured to select the second high pass filter, there are instances in which the detection signal from the second electrode is input into the grip detection circuit via the second high pass filter, and there are instances in which the detection signal from the second electrode is input into the electrocardiographic detection circuit via the second low pass filter. Accordingly, the presence of dead regions in the grip detection and ECG waveform detection, and a reduction in electrode sensitivity, like is seen with conventional techniques, are less likely to occur.

Moreover, since providing the first electrode and the second electrode on the steering wheel allows for both grip detection and ECG waveform detection to be performed, the installment of the measurement device is simplified.

Moreover, in the measurement device according to another aspect of the present disclosure, when an amplitude of an ECG waveform detected by the electrocardiographic detection circuit is less than a predetermined value, the first selector selects the first high pass filter for a predetermined period, and the second selector selects the second high pass filter for the predetermined period.

Since the heartbeat based on the ECG waveform is the pulsing of the heart that occurs in a regular cycle, the interval between pulses, that is to say, the period between two adjacent pulses is the predetermined period in which the heartbeat is not detected. With the measurement device according to the present disclosure, in the predetermined period in which the amplitude of the ECG waveform is less than the predetermined value, the first selector selects the first high pass filter and the second selector selects the second high pass filter. In the period other than the predetermined period, the first selector selects the first low pass filter and the second selector selects the second low pass filter. Accordingly, with this measurement device, since the grip detection and the ECG waveform detection can be performed as a result of the predetermined period and the period other than the predetermined period repeating in a cycle, like the ECG waveform does, it is possible to ensure that the grip detection and the ECG waveform detection are performed.

Moreover, in the measurement device according to another aspect of the present disclosure, the first selector selects both the first low pass filter and the first high pass filter.

This makes it possible to perform electrocardiographic detection and grip detection concurrently. This in turn makes it possible to improve the sensitivity of the electrodes since the dead regions of the ECG waveform detection and the grip detection are reduced. Moreover, by using the electrocardiographic detection and the grip detection to determine whether the driver is gripping the steering wheel or not and determine whether the driver is sitting in the driver's seat or not, the driver can be prompted to grip the steering wheel, alerted to sit with correct posture in the driver's seat, etc., to improve the safety of the driver that drives the vehicle.

Moreover, in the measurement device according to another aspect of the present disclosure, the second selector selects both the second low pass filter and the second high pass filter in synchronization with the first selector.

With this configuration as well, it possible to perform electrocardiographic detection and grip detection concurrently. This in turn makes it possible to improve the sensitivity of the electrodes since the dead regions of the grip detection and the ECG waveform detection are reduced. Moreover, by using the grip detection and the electrocardiographic detection to determine whether the driver is gripping the steering wheel or not and determine whether the driver is sitting in the driver's seat or not, the driver can be prompted to grip the steering wheel, alerted to sit with correct posture in the driver's seat, etc., to improve the safety of the driver that drives the vehicle.

Moreover, in the measurement device according to another aspect of the present disclosure, on a condition that a noise level of at least one of a detection signal input into the electrocardiographic detection circuit and a detection signal input into the grip detection circuit is greater than or equal to a predetermined noise level in a state in which both the first low pass filter and the first high pass filter are selected by the first selector and both the second low pass filter and the second high pass filter are selected by the second selector, when an amplitude of an ECG waveform detected by the electrocardiographic detection circuit is less than a predetermined value: the first selector selects the first high pass filter for a predetermined period; and the second selector selects the second high pass filter for the predetermined period.

In this way, if the noise level of the detection signal that is input into the electrocardiographic detection circuit or the noise level of the detection signal that is input into the grip detection circuit is greater than or equal to the predetermined noise level, when both the ECG waveform and the gripping are detected concurrently, accuracy cannot be ensured, so one of the ECG waveform and the gripping is selectively detected. Thus, when the amplitude of the ECG waveform detected by the electrocardiographic detection circuit is less than the predetermined value, this means that the heart is between two pulses (for example, between two adjacent pulses), i.e., is not pulsing at that point in time, so in the predetermined period in which the heart is not pulsing, the first selector is caused to select the first high pass filter and the second selector is caused to select the second high pass filter, whereby the grip detection is performed. Then, the electrocardiographic detection is performed by causing the first selector to select the first low pass filter and causing the second selector to select the second low pass filter after elapse of the predetermined period. By repeating these operations, if the noise level is low, both the ECG waveform and the gripping are detected concurrently to save time, and if the noise level is high, the ECG waveform and the gripping are selectively detected by time-division based on the predetermined period to inhibit the mutual influence of noise on ECG waveform and gripping detection.

Moreover, the measurement device according to another aspect of the present disclosure further includes: a first voltage follower circuit electrically connected to the first low pass filter and the electrocardiographic detection circuit; and a second voltage follower circuit electrically connected to the second low pass filter and the electrocardiographic detection circuit. A wiring distance from the first low pass filter to the first electrode is shorter than a wiring distance from the first low pass filter to the electrocardiographic detection circuit, and a wiring distance from the first voltage follower circuit to the first electrode is shorter than a wiring distance from the first voltage follower circuit to the electrocardiographic detection circuit. A wiring distance from the second low pass filter to the second electrode is shorter than a wiring distance from the second low pass filter to the electrocardiographic detection circuit, and a wiring distance from the second voltage follower circuit to the second electrode is shorter than a wiring distance from the second voltage follower circuit to the electrocardiographic detection circuit.

With this configuration, on the wiring path from the first electrode to the electrocardiographic detection circuit, the first low pass filter and the first voltage follower circuit are disposed closer to the first electrode than to the electrocardiographic detection circuit. Moreover, on the wiring path from the second electrode to the electrocardiographic detection circuit, the second low pass filter and the second voltage follower circuit are disposed closer to the second electrode than to the electrocardiographic detection circuit. The first voltage follower circuit on the wiring path from the first electrode to the electrocardiographic detection circuit and the second voltage follower circuit on the wiring path from the second electrode to the electrocardiographic detection circuit can convert the output impedance of the wiring paths to the electrocardiographic detection circuit to a low impedance. Accordingly, with this measurement device, it is possible to inhibit the influence of noise on the wiring paths between the first and second voltage follower circuits and the electrocardiographic detection circuit.

Moreover, in the measurement device according to another aspect of the present disclosure, the second electrode is provided on the front surface section, and the electrocardiographic detection circuit is electrically connected to the first low pass filter and the second electrode.

This configuration makes it possible to utilize a part of the body that is characterized by a conductive path through the body—from the hand of the driver to the thigh of the driver—that is longer than the conductive path from the left hand of the driver to the right hand of the driver. In other words, the potential difference between the potential of the first electrode that detects one hand of the driver and the potential of the second electrode that detects the thigh of driver is greater than the potential difference between the potential of the first electrode when configured to detect the right hand of the driver and the potential of the second electrode when configured to detect the left hand of the driver. Consequently, with the measurement device according to the present disclosure, an ECG waveform can be measured more accurately.

Moreover, in the measurement device according to another aspect of the present disclosure, when an amplitude of an ECG waveform detected by the electrocardiographic detection circuit is less than a predetermined value, the first selector selects the first high pass filter for a predetermined period.

With this configuration, in the predetermined period in which the amplitude of the ECG waveform is less than the predetermined value, the first selector selects the first high pass filter. In the period other than the predetermined period, the first selector selects the first low pass filter. Accordingly, with this measurement device, since the grip detection and the ECG waveform detection can be performed as a result of the predetermined period and the period other than the predetermined period repeating in a cycle, like the ECG waveform does, it is possible to ensure that the grip detection and the ECG waveform detection are performed.

Moreover, the measurement device according to another aspect of the present disclosure further includes a third electrode provided in a different location on the steering wheel than the first electrode. The third electrode is electrically connected to the grip detection circuit via a second high pass filter different from the first high pass filter.

With this configuration, since it is possible to determine whether the driver is gripping the steering wheel with both hands, the driver can be, for example, alerted to grip the steering wheel with both hands in order to improve the safety of the driver driving the vehicle.

Moreover, since the measurement device includes the first electrode as well, the potential difference between the first electrode or the third electrode that detects one hand and the second electrode that detects the thigh can be measured. Accordingly, the measurement device can measure an ECG waveform more accurately. In other words, the measurement device can improve the accuracy of grip detection and ECG waveform detection performed using both hands.

Moreover, in the measurement device according to another aspect of the present disclosure, the grip detection circuit outputs, independently of each other, a signal indicating a detection result according to a detection signal resulting from detection by the first electrode and a signal indicating a detection result according to a detection signal resulting from detection by the third electrode.

As described above, this configuration makes it possible to determine whether the driver is gripping the steering wheel with both hands or not. Accordingly, with this measurement device, the safety of the driver driving the vehicle can be further increased.

Moreover, the measurement device according to another aspect of the present disclosure further includes: a fourth electrode provided on the front surface section in a different location than the second electrode; a second low pass filter electrically connected to the third electrode, the second low pass filter being different from the first low pass filter; a second selector electrically connected between the third electrode and the second high pass filter and electrically connected between the third electrode and the second low pass filter; a multiplexer provided between (i) the electrocardiographic detection circuit and (ii) the first low pass filter, the second low pass filter, the second electrode, and the fourth electrode, the multiplexer being electrically connected to the electrocardiographic detection circuit, the first low pass filter, the second low pass filter, the second electrode, and the fourth electrode; and a control circuit electrically connected to the multiplexer. The control circuit switches the multiplexer so as to cause the electrocardiographic detection circuit to output a signal indicating detection results according to two of the four detection signals from the first electrode, the second electrode, the third electrode, and the fourth electrode.

With this configuration, the control circuit can cause the multiplexer to extract two of the four detection signals from the first electrode, the second electrode, the third electrode, and the fourth electrode by switching the multiplexer. Stated differently, since the control circuit can arbitrarily select two of the four electrodes, this measurement device can perform grip detection and ECG waveform detection suited to the driver's posture, for example.

Moreover, the measurement device according to another aspect of the present disclosure further includes: a fourth electrode provided on the front surface section in a different location than the second electrode; a second low pass filter electrically connected to the third electrode, the second low pass filter being different from the first low pass filter; a second selector electrically connected between the third electrode and the second high pass filter and electrically connected between the third electrode and the second low pass filter; and a control circuit electrically connected to the electrocardiographic detection circuit. The electrocardiographic detection circuit includes: a first amplification circuit that is electrically connected to at least one of the first low pass filter and the second low pass filter and electrically connected to the second electrode; a second amplification circuit that is electrically connected to at least one of the first low pass filter and the second low pass filter or the fourth electrode, and electrically connected to the second electrode; and a multiplexer electrically connected to output sides of each of the first amplification circuit and the second amplification circuit. The control circuit switches the multiplexer so that (i) one of the first electrode, the third electrode, and the fourth electrode and (ii) the electrocardiographic detection circuit are electrically connected.

With this configuration, as a result of the control circuit switching the multiplexer, it is possible to select a given potential difference from among three potential differences—namely the potential difference between the potential of the first electrode and the potential of the second electrode, the potential difference between the potential of the third electrode and the potential of the second electrode, and the potential difference between the potential of the fourth electrode and the potential of the second electrode. In other words, the control circuit can cause the multiplexer to extract one amplification signal from among the amplification signals output from the amplification circuits. As a result, the control circuit can select an appropriate amplification signal from among a plurality of amplification signals, whereby the measurement device can further improve the accuracy of the grip detection and the ECG waveform detection.

Moreover, in the measurement device according to another aspect of the present disclosure, the control circuit: is connected to the electrocardiographic detection circuit; sequentially switches the multiplexer so as to sequentially select all possible combinations of electrical connections between (i) any two of the first electrode, the second electrode, the third electrode, and the fourth electrode and (ii) the electrocardiographic detection circuit; and when the first selector is selecting the first low pass filter and the second selector is selecting the second low pass filter, controls the multiplexer so as to output a combination of detection signals from the two electrodes whose detection signals exhibit the greatest output width, from among all the combinations of two electrodes.

With this configuration, when the first low pass filter and the second low pass filter are selected, by extracting, from among the four detection signals from the four electrodes—the first electrode, the second electrode, the third electrode, and the fourth electrode—an optimal combination of two detection signals, that is, the combination that has the greatest output width, the control circuit can select the combination of the two electrodes that correspond to the two extracted detection signals. In other words, the control circuit can select the combination of the two electrodes that have the greatest potential difference. Accordingly, with this measurement device, the accuracy of the ECG waveform detection can be increased with more certainty.

Moreover, in the measurement device according to another aspect of the present disclosure, an output of the first low pass filter and an output of the second low pass filter are combined and input into the electrocardiographic detection circuit, and the second selector alternately selects the second low pass filter and the second high pass filter in synchronization with the first selector.

With this configuration, the detection signal from the first electrode and the detection signal from the third electrode are combined and input into the electrocardiographic detection circuit. Accordingly, the first electrode and the third electrode behave as a single electrode. This increases the surface area of the electrodes that oppose the hands of the driver, which increases the accuracy of the ECG waveform detection with more certainty.

Moreover, the measurement device according to another aspect of the present disclosure further includes a first voltage follower circuit electrically connected to the first low pass filter and the electrocardiographic detection circuit. A wiring distance from the first low pass filter to the first electrode is shorter than a wiring distance from the first low pass filter to the electrocardiographic detection circuit, and a wiring distance from the first voltage follower circuit to the first electrode is shorter than a wiring distance from the first voltage follower circuit to the electrocardiographic detection circuit.

With this configuration, on the wiring path from the first electrode to the electrocardiographic detection circuit, the first low pass filter and the first voltage follower circuit are disposed closer to the first electrode than to the electrocardiographic detection circuit. The first voltage follower circuit on the wiring path from the first electrode to the electrocardiographic detection circuit can convert the output impedance of the wiring path to the electrocardiographic detection circuit to a low impedance. Accordingly, with this measurement device, it is possible to inhibit the influence of noise on the wiring path between the first voltage follower circuit and the electrocardiographic detection circuit.

Moreover, the measurement device according to another aspect of the present disclosure further includes: a first voltage follower circuit electrically connected to the first low pass filter and the electrocardiographic detection circuit; and a second voltage follower circuit electrically connected to the second low pass filter and the electrocardiographic detection circuit. A wiring distance from the first low pass filter to the first electrode is shorter than a wiring distance from the first low pass filter to the electrocardiographic detection circuit, and a wiring distance from the first voltage follower circuit to the first electrode is shorter than a wiring distance from the first voltage follower circuit to the electrocardiographic detection circuit. A wiring distance from the second low pass filter to the third electrode is shorter than a wiring distance from the second low pass filter to the electrocardiographic detection circuit, and a wiring distance from the second voltage follower circuit to the third electrode is shorter than a wiring distance from the second voltage follower circuit to the electrocardiographic detection circuit.

With this configuration, on the wiring path from the first electrode to the electrocardiographic detection circuit, the first low pass filter and the first voltage follower circuit are disposed closer to the first electrode than to the electrocardiographic detection circuit. Moreover, on the wiring path from the third electrode to the electrocardiographic detection circuit, the second low pass filter and the second voltage follower circuit are disposed closer to the third electrode than to the electrocardiographic detection circuit. The first voltage follower circuit on the wiring path from the first electrode to the electrocardiographic detection circuit and the second voltage follower circuit on the wiring path from the third electrode to the electrocardiographic detection circuit can convert the output impedance of the wiring paths to the electrocardiographic detection circuit to a low impedance. Accordingly, with this measurement device, it is possible to inhibit the influence of noise on the wiring paths between the first and second voltage follower circuits and the electrocardiographic detection circuit.

The measurement device according to one aspect of the present disclosure further includes a control circuit electrically connected to the electrocardiographic detection circuit and the grip detection circuit. The control circuit outputs a normal grip signal when the electrocardiographic detection circuit detects an ECG waveform and the grip detection circuit detects a grip.

Typically, the frequency of the detection signal indicating an ECG waveform is lower than the frequency of the detection signal indicating a grip. In the present disclosure, in a state in which the driver is sitting in the driver's seat and gripping the steering wheel, the detection signal from the first electrode is input into the grip detection circuit via the first high pass filter and the detection signal from the second electrode is input into the grip detection circuit via the second high pass filter. Moreover, in this state, the detection signal from the first electrode is input into the electrocardiographic detection circuit via the first low pass filter and the detection signal from the second electrode is input into the electrocardiographic detection circuit via the second low pass filter. Accordingly, the grip detection circuit can perform grip detection based on changes in electrostatic capacitance between the first electrode and the driver's hand, from the detection signal input via the first high pass filter. Moreover, the electrocardiographic detection circuit can detect the ECG waveform of the driver from the potential difference between the potential of the first electrode and the potential of the second electrode. Accordingly, the presence of dead regions in the grip detection and the ECG waveform detection, and a reduction in electrode sensitivity, like is seen with conventional techniques, are less likely to occur.

Accordingly, the accuracy of the grip detection and the ECG waveform detection can be inhibited from decreasing. As a result, it can be ensured that the control circuit will output a normal grip signal when the grip detection circuit detects an ECG waveform and it can be ensured that the control circuit will output a normal grip signal when electrocardiographic detection circuit detects an ECG waveform.

In particular, as a result of each of the first electrode and the second electrode being used commonly as both an electrode for the grip detection and an electrode for the ECG waveform detection, the same electrode can be used to perform the grip detection and the ECG waveform detection. Accordingly, cases in which there is a region of the steering wheel in which grip of the steering wheel cannot be detected, and there is another region of the steering wheel in which an ECG waveform cannot be detected, that is to say, cases in which both the grip detection and the ECG waveform detection have dead regions, are unlikely. Consequently, grip detection and ECG waveform detection can be performed with certainty.

Moreover, with this measurement device, since grip detection and ECG waveform detection need not be performed using respective electrodes, the manufacturing cost of the measurement device can be inhibited from steeply increasing and the structure of the measurement device can be kept from becoming overly complicated.

Moreover, with the measurement device, since an electrode for ECG waveform detection and an electrode for grip detection need not be wrapped around the rim, the steering wheel can be inhibited from being difficult to grip due to an increase in the thickness of the steering wheel cover.

Moreover, in the measurement device according to another aspect of the present disclosure, the second electrode is: provided in a different location on the steering wheel than the first electrode; electrically connected to the grip detection circuit via a second high pass filter different from the first high pass filter; and electrically connected to the electrocardiographic detection circuit via a second low pass filter different from the first low pass filter. The control circuit outputs a normal grip signal when the electrocardiographic detection circuit detects an ECG waveform and the grip detection circuit detects a grip.

With this configuration, since providing the first electrode and the second electrode on the steering wheel allows for both grip detection and ECG waveform detection to be performed, the installment of the measurement device is simplified.

Moreover, with the measurement device, if the grip detection and the ECG waveform detection are performed concurrently, it is possible to estimate that the driver is correctly gripping the steering wheel with both hands.

Moreover, in the measurement device according to another aspect of the present disclosure, the grip detection circuit outputs to the control circuit, independently of each other, a signal indicating a detection result according to a detection signal resulting from detection by the first electrode and a signal indicating a detection result according to a detection signal resulting from detection by the second electrode. The control circuit outputs a normal grip signal when the grip detection circuit detects a grip via both the first electrode and the second electrode, and outputs an insufficient grip signal when the grip detection circuit detects a grip via only one of the first electrode and the second electrode.

With this configuration, the normal grip signal can be output when the driver is gripping the steering wheel with both hands, and the insufficient grip signal can be output when the driver is not gripping the steering wheel with both hands. Accordingly, by, for example, determining whether the driver is appropriately gripping the steering wheel with both hands when control of the vehicle is handed over to the driver from a semiautonomous or autonomous driving state, the driver can be, for example, alerted to the grip steering wheel with both hands in order to improve the safety of the driver driving the vehicle.

Moreover, in the measurement device according to another aspect of the present disclosure, the second electrode is provided on the front surface section.

This configuration makes it possible to utilize a part of the body that is characterized by a conductive path through the body—from the hand of the driver to the thigh of the driver—that is longer than the conductive path from the left hand of the driver to the right hand of the driver. In other words, the potential difference between the potential of the first electrode that detects one hand of the driver and the potential of the second electrode that detects the thigh of driver is greater than the potential difference between the potential of the first electrode when configured to detect the right hand of the driver and the potential of the second electrode when configured to detect the left hand of the driver. Consequently, with the measurement device according to the present disclosure, an ECG waveform can be measured more accurately.

Moreover, the measurement device according to another aspect of the present disclosure further includes a third electrode provided in a different location on the steering wheel than the first electrode. The third electrode is electrically connected to the grip detection circuit via a second high pass filter different from the first high pass filter.

With this configuration, since it is possible to determine whether the driver is gripping the steering wheel with both hands, the driver can be, for example, alerted to grip the steering wheel with both hands in order to improve the safety of the driver driving the vehicle.

Moreover, since the measurement device includes the first electrode as well, the potential difference between the first electrode or the third electrode that detects one hand and the second electrode that detects the thigh can be measured. Accordingly, the measurement device can measure an ECG waveform more accurately. In other words, the measurement device can improve the accuracy of grip detection and ECG waveform detection performed using both hands.

Moreover, in the measurement device according to another aspect of the present disclosure, the grip detection circuit outputs to the control circuit, independently of each other, a detection result according to a detection signal resulting from detection by the first electrode and a detection result according to a detection signal resulting from detection by the third electrode. The control circuit outputs a normal grip signal when the grip detection circuit detects a grip via both the first electrode and the third electrode, and outputs an insufficient grip signal when the grip detection circuit detects a grip via only one of the first electrode and the third electrode.

As described above, this configuration makes it possible to determine whether the driver is gripping the steering wheel with both hands or not. Accordingly, with this measurement device, the safety of the driver driving the vehicle can be further increased by, for example, alerting the driver to grip the steering wheel with both hands, based on the insufficient grip signal.

Moreover, the measurement device according to another aspect of the present disclosure further includes: a fourth electrode provided on the front surface section in a different location than the second electrode; a first low pass filter electrically connected to the first electrode; a second low pass filter electrically connected to the third electrode, the second low pass filter being different from the first low pass filter; and a multiplexer provided between (i) the electrocardiographic detection circuit and (ii) the first low pass filter, the second low pass filter, the second electrode, and the fourth electrode, the multiplexer being electrically connected to the electrocardiographic detection circuit, the first low pass filter, the second low pass filter, the second electrode, and the fourth electrode. The multiplexer is electrically connected to the control circuit. The electrocardiographic detection circuit includes an amplification circuit electrically connected to the multiplexer. The control circuit switches the multiplexer so as to cause the electrocardiographic detection circuit to output detection results according to two of the four detection signals from the first electrode, the second electrode, the third electrode, and the fourth electrode.

With this configuration, the control circuit can cause the multiplexer to extract two of the four detection signals from the first electrode, the second electrode, the third electrode, and the fourth electrode by switching the multiplexer. Stated differently, since the control circuit can arbitrarily select two of the four electrodes, this measurement device can perform grip detection and ECG waveform detection suited to the driver's posture, for example.

Moreover, the measurement device according to another aspect of the present disclosure further includes: a fourth electrode provided on the front surface section in a different location than the second electrode; a first low pass filter electrically connected to the first electrode; second low pass filter electrically connected to the third electrode, the second low pass filter being different from the first low pass filter; and a control circuit electrically connected to the electrocardiographic detection circuit. The electrocardiographic detection circuit includes: a first amplification circuit that is electrically connected to at least one of the first low pass filter and the second low pass filter and electrically connected to the second electrode; a second amplification circuit that is electrically connected to at least one of the first low pass filter and the second low pass filter or the fourth electrode, and electrically connected to the second electrode; and a multiplexer electrically connected to output sides of each of the first amplification circuit and the second amplification circuit. The control circuit switches the multiplexer so that (i) one of the first electrode, the third electrode, and the fourth electrode and (ii) the electrocardiographic detection circuit are electrically connected.

With this configuration, as a result of the control circuit switching the multiplexer, it is possible to select a given potential difference from among three potential differences—namely the potential difference between the potential of the first electrode and the potential of the second electrode, the potential difference between the potential of the third electrode and the potential of the second electrode, and the potential difference between the potential of the fourth electrode and the potential of the second electrode. In other words, the control circuit can cause the multiplexer to extract one amplification signal from among the amplification signals output from the amplification circuits. As a result, the control circuit can select an appropriate amplification signal from among a plurality of amplification signals, whereby the measurement device can further improve the accuracy of the grip detection and the ECG waveform detection.

Moreover, in the measurement device according to another aspect of the present disclosure, the control circuit outputs an insufficient grip signal when an amplitude of the ECG waveform detected by the electrocardiographic detection circuit is less than a predetermined value.

For example, even if a detection signal is input into the electrocardiographic detection circuit, if the amplitude of the ECG waveform indicated in this detection signal is less than the predetermined value, the driver may not be sufficiently gripping the steering wheel or the posture of the driver may be poor, that is to say, the driver may be sitting in the driver's seat with incorrect posture.

According to the present disclosure, when the amplitude of the ECG waveform indicated in this detection signal is less than the predetermined value, for example, the driver can be alerted to grip the steering wheel with both hands or alerted to sit in the driver's seat with correct posture, based on the insufficient grip signal. Accordingly, with this measurement device, the safety of the driver driving the vehicle can be increased more certainty.

Moreover, in the measurement device according to another aspect of the present disclosure, the control circuit outputs an anomaly signal when the grip detection circuit detects the grip and the electrocardiographic detection circuit does not detect the ECG waveform.

For example, when the electrocardiographic detection circuit does not detect an ECG waveform even through the grip detection circuit detects a grip, there may be a possibility that a person from a passenger seat is gripping the steering wheel, or that a conductive material has been wrapped around the steering wheel.

According to the present disclosure, even if the grip detection circuit detects a grip, if the electrocardiographic detection circuit does not detect an ECG waveform, the control circuit can, for example, alert the driver to sit with correct posture in the driver's seat or to grip the steering wheel, based on the anomaly signal. Accordingly, with this measurement device, the safety of the driver driving the vehicle can be increased more certainty.

Hereinafter, embodiments are described in detail with reference to the drawings.

Note that each of the non-limiting embodiments described below shows a general or specific example. The numerical values, shapes, materials, elements, the arrangement and connection of the elements, steps, the processing order of the steps etc., presented in the following non-limiting, exemplary embodiments are mere examples, and therefore do not limit the present disclosure. Among the elements in the following non-limiting, exemplary embodiments, those not recited in any one of the independent claims defining the broadest aspect are described as optional elements.

Note that the respective figures are schematic diagrams and are not necessarily precise illustrations. Additionally, like elements share like reference numbers. In the following embodiments, phrases such as “approximately T-shaped” are used. For example, “approximately T-shaped” means, in addition to being exactly T-shaped, being essentially T-shaped, or stated differently, being within a margin of error of about a few percent from being exactly T-shaped. Moreover, as used herein, “approximately T-shaped” means T-shaped within a range in which the advantageous effects of the present disclosure can be achieved. This applies to other phrases where “approximately” is used as well.

### Embodiment 1

### Vehicle Configuration

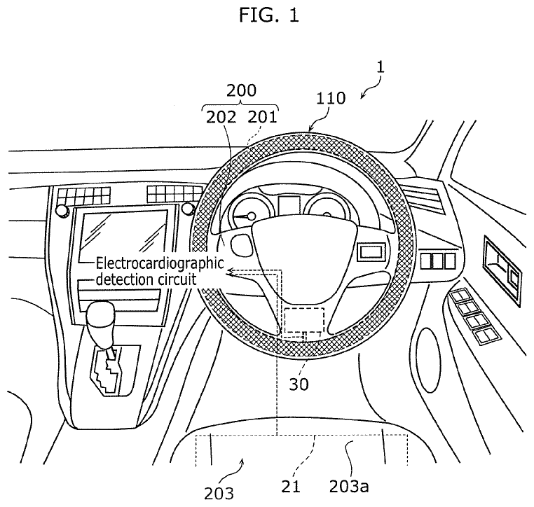

FIG. 1 illustrates one example of the interior of a vehicle equipped with measurement device 1 according to Embodiment 1.

As illustrated in FIG. 1, the vehicle includes steering wheel 200, a speaker, a display device such as a liquid crystal display, and measurement device 1. The speaker and the display device are configured as, for example, alerting devices.

Steering wheel 200 applies a steering angle to the handle of the vehicle. Steering wheel 200 includes rim 201, an approximately T-shaped spoke 202 integrally formed with rim 201, and a horn switch cover that covers the horn switch (not illustrated) disposed in the central region of spoke 202.

Rim 201 is the ring-shaped portion of steering wheel 200 that the driver (person) grips. Rim 201 is wrapped with steering wheel cover 110.

### Measurement Device 1

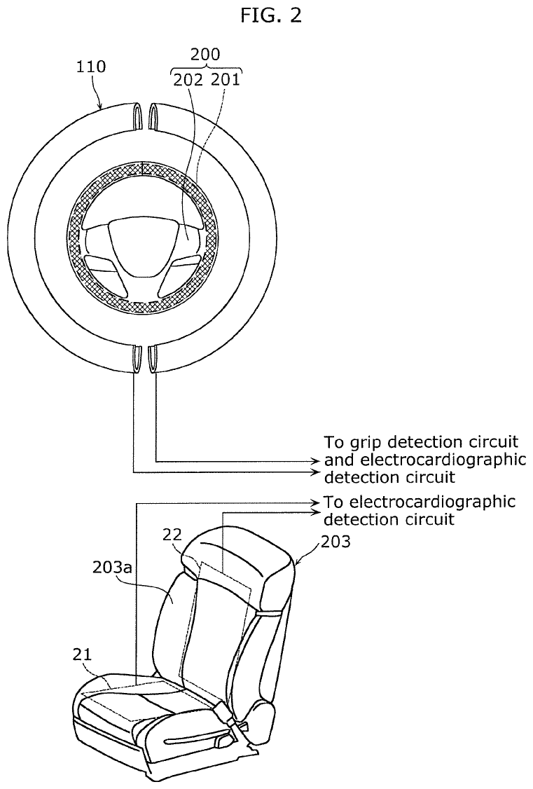

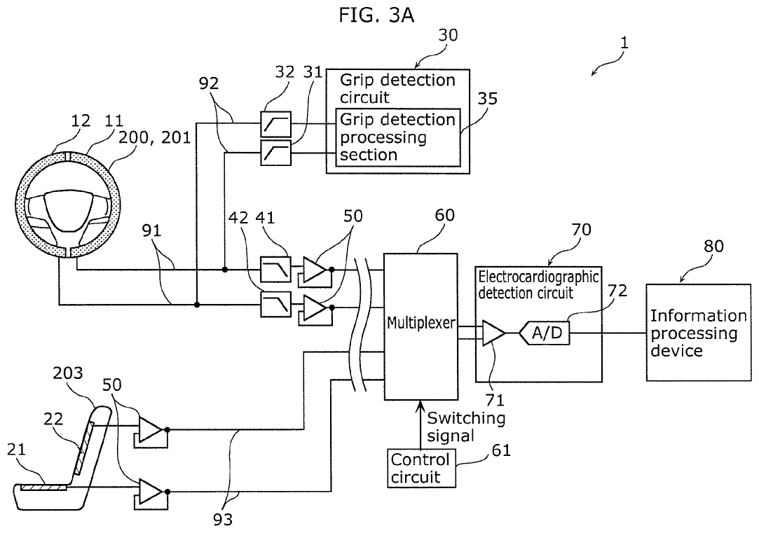

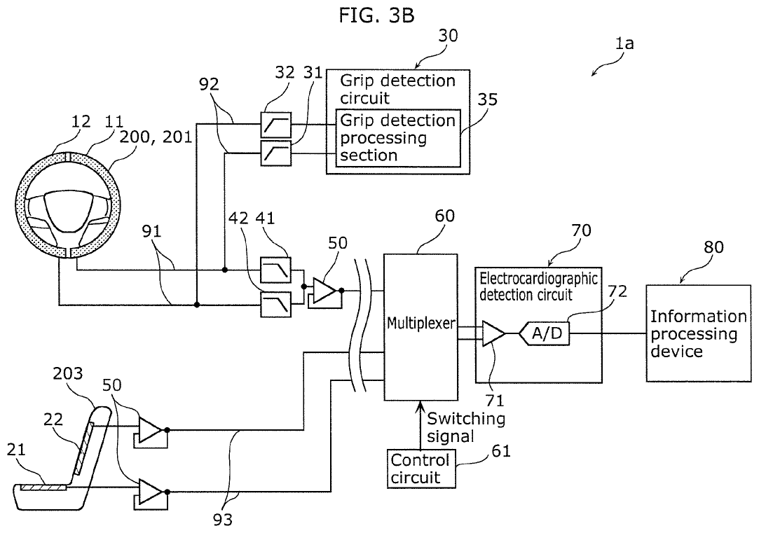

FIG. 2 schematically illustrates an example of steering wheel cover 110 and driver's seat 203 according to Embodiment 1. FIG. 3A is a block diagram of measurement device 1 according to Embodiment 1.

As illustrated in FIG. 2 and FIG. 3A, measurement device 1 is equipped in a vehicle, and performs ECG waveform detection by measuring an ECG waveform, which is biometric information, of the driver, and grip detection which detects the gripping of steering wheel cover 110 by the driver. ECG waveform detection detects a heartbeat based on an electrocardiographic detection signal indicated in detection signals output by first cover electrode 11, second cover electrode 12, first seat electrode 21, and second seat electrode 22. In the present embodiment, the ECG waveform detection detects a heartbeat based on an electrocardiographic detection signal that indicates a potential difference between two detection signals among the four detection signals output by the electrodes.

Measurement device 1 includes first cover electrode 11, second cover electrode 12, first seat electrode 21, second seat electrode 22, first high pass filter 31, second high pass filter 32, grip detection circuit 30, first low pass filter 41, second low pass filter 42, a plurality of voltage follower circuits 50, multiplexer 60, control circuit 61, electrocardiographic detection circuit 70, and information processing device 80.

### First Cover Electrode 11 and Second Cover Electrode 12

First cover electrode 11 and second cover electrode 12 are provided internally in steering wheel cover 110 provided on steering wheel 200. First cover electrode 11 and second cover electrode 12 are sensor electrodes that detect contact of steering wheel cover 110 by the driver's hand. In a state in which steering wheel cover 110 is wrapped around rim 201, first cover electrode 11 is provided on one side of rim 201, along the circumferential direction of rim 201. Second cover electrode 12 is provided in a different location on steering wheel 200 than first cover electrode 11. More specifically, in a state in which steering wheel cover 110 is wrapped around rim 201, second cover electrode 12 is provided on the other side of rim 201, along the circumferential direction of rim 201. For example, in a state in which steering wheel cover 110 is wrapped around rim 201, when rim 201 is viewed from the front, first cover electrode 11 is provided on the right side of rim 201, and second cover electrode 12 is provided on the left side of rim 201. First cover electrode 11 is one example of the first electrode, and second cover electrode 12 is one example of the third electrode.

Here, “contact” includes, in addition to direct contact of steering wheel cover 110 by the driver's hand, indirect contact of steering wheel cover 110 by way of an object, as well as includes a state in which a person's hand is removed from steering wheel cover 110—so long as first cover electrode 11 and second cover electrode 12 can detect a person's hand.

Moreover, each of first cover electrode 11 and second cover electrode 12 is a flat electrode having a planar structure of a conductive element or resistive element, and is a plate- or sheet-shaped conductive electrode configured of a thin plate of metal. Note that as a result of using flat electrodes for first cover electrode 11 and second cover electrode 12, the surface area of contact between the electrodes and a hand can be maximized, which increases the sensitivity of both the grip detection and the ECG waveform detection.

First cover electrode 11 and second cover electrode 12 are electrically connected to first high pass filter 31 and second high pass filter 32 via wiring 91 and 92, respectively. Wiring 92 is electrically connected to wiring 91 and branches from wiring 91.

First cover electrode 11 and second cover electrode 12 are electrically connected to first low pass filter 41 and second low pass filter 42, respectively, via wiring 91. When first cover electrode 11 detects contact of steering wheel cover 110 by the driver's hand, first cover electrode 11 inputs a detection signal into first high pass filter 31 and first low pass filter 41, and when second cover electrode 12 detects contact of steering wheel cover 110 by the driver's hand, second cover electrode 12 inputs a detection signal to second high pass filter 32 and second low pass filter 42.

Moreover, the front surface of each of first cover electrode 11 and second cover electrode 12 is covered by a surface component (not illustrated). The surface components are the parts that the driver's hands come in contact with, and form the surface of steering wheel cover 110. In other words, the surface components are the parts that the driver directly contacts with his or her hands when gripping rim 201. The surface components may be made of leather, wood, resin, etc.

The back surface of each of first cover electrode 11 and second cover electrode 12 is covered by a base material (not illustrated). The base material is an elongated, sheet-shaped non-woven fabric that is elastic and ductile. For example, the base material may be made from a composite resin, such as polyethylene (PE) or polyethylene-terephthalate (PET).

Moreover, a ground terminal (not illustrated) is provided on the back surface of the base material. In other words, the ground terminal is disposed between rim 201 and the base material. The ground terminal is, for example, a metal wire (conductive wire) such as a copper wire, or a flat electrode having a planar structure.

Although first cover electrode 11 and second cover electrode 12 are used in steering wheel cover 110 according to the present embodiment, these two electrodes may be unified as a single electrode. Moreover, three or more electrodes may be used in steering wheel cover 110. In such cases, steering wheel cover 110 may be provided with two ground terminals, one for each first cover electrode 11 and second cover electrode 12, may be provided with a single unified ground terminal, or may be provided with three or more ground terminals. The number of sensor electrodes and the number of ground terminals provided do not necessarily need to be the same. First Seat Electrode 21 and Second Seat Electrode 22

First seat electrode 21 and second seat electrode 22 are provided on front surface section 203a of driver's seat 203 illustrated in FIG. 2, and are sensor electrodes that detect contact between the torso of the driver and the seat cover that covers driver's seat 203. Here, front surface section 203a of driver's seat 203 is the seat cover part that contacts the driver when the driver sits in driver's seat 203. In the present embodiment, first seat electrode 21 is provided on the back surface of the seat cover part that contacts the driver's thighs, and detects contact between the driver's thigh and the seat cover. Moreover, second seat electrode 22 is provided on the back surface of the seat cover part that contacts the driver's back, and detects contact between the driver's back and the seat cover. The back surface of the seat cover part is the surface on the opposite side from the surface of the seat cover that the driver comes into contact with (i.e., the front surface). First seat electrode 21 is one example of the second electrode, and second seat electrode 22 is one example of the fourth electrode.

First seat electrode 21 and second seat electrode 22 are flat electrodes having a planar structure of a conductive element or a resistive element that are provided on the seat cover, and are plate- or sheet-shaped conductive electrodes configured of a thin plate of metal. Without directly contacting the skin of the driver through the seat cover, first seat electrode 21 and second seat electrode 22 form a virtual capacitor with the body of the driver to detect a potential of the driver from changes in electrostatic capacitance.

Each of first seat electrode 21 and second seat electrode 22 is electrically connected to multiplexer 60 via wiring 93 and voltage follower circuit 50.

Although first seat electrode 21 and second seat electrode 22 are used in driver's seat 203 according to the present embodiment, these two electrodes may be unified as a single electrode. Moreover, three or more electrodes may be used in driver's seat 203. First High Pass Filter 31 and Second High Pass Filter 32

First high pass filter 31 is provided on wiring 91 and 92 (on wiring 92 in the present embodiment) that electrically connect first cover electrode 11 and grip detection circuit 30, and second high pass filter 32 is a filter different from first high pass filter 31 that is provided on wiring 91 and 92 (wiring 92 in the present embodiment) that electrically connect second cover electrode 12 and grip detection circuit 30. First high pass filter 31 and second high pass filter 32 are electrically connected to grip detection processing section 35 via wiring 92.

First high pass filter 31 is a filter device that produces a detection signal of a predetermined frequency or higher by removing low frequency components of the detection signal from first cover electrode 11. Second high pass filter 32 is a filter device that produces a detection signal of a predetermined frequency or higher by removing low frequency components of the detection signal from second cover electrode 12. Each of first high pass filter 31 and second high pass filter 32 inputs a detection signal of a predetermined frequency or higher into grip detection circuit 30. Here, the predetermined frequency is, for example, 100 kHz.

### Grip Detection Circuit 30

For example, grip detection circuit 30 is embedded in spoke 202. Grip detection circuit 30 is electrically connected to first cover electrode 11 and second cover electrode 12 and the like. Grip detection circuit 30 is a sensor that detects contact of the surface of steering wheel cover 110 by the driver's hand, based on the detection signals output from first cover electrode 11 and second cover electrode 12. Grip detection circuit 30 detects whether the driver's hand is contacting steering wheel cover 110 or not, that is to say, detects contact by the hand and detects the position of the contact by the hand, etc.

Grip detection circuit 30 includes grip detection processing section 35.

Grip detection processing section 35 is electrically connected to first cover electrode 11 via first high pass filter 31, and electrically connected to second cover electrode 12 via second high pass filter 32. Grip detection processing section 35 includes a sensor circuit that detects contact between steering wheel cover 110 and a hand.

Moreover, for example, grip detection circuit 30 forms, via first cover electrode 11 and second cover electrode 12, an electrostatic capacitive proximity sensor, whereby grip detection circuit 30 functions as a grip sensor that detects a grip by the driver (a person) in the vehicle. A grip sensor detects whether the driver's hand contacted steering wheel cover 110 or not based on changes in electrostatic capacitance between the driver's hand and first cover electrode 11, as well as changes in electrostatic capacitance between the driver's hand and second cover electrode 12.

Specifically, grip detection processing section 35 passes alternating current to first cover electrode 11 and second cover electrode 12 via wiring 91 and 92. When the driver's hand contacts the surface of steering wheel cover 110, the electrostatic capacitance of first cover electrode 11 and second cover electrode 12 changes in the contacted regions. Accordingly, grip detection processing section 35 estimates changes in electrostatic capacitance in first cover electrode 11 and second cover electrode 12 based on the value of the current flowing to first cover electrode 11 and second cover electrode 12. For example, in a state in which the driver's hands are separated from steering wheel cover 110, the electrostatic capacitance detected by grip detection processing section 35 is between the vehicle and first and second cover electrodes 11 and 12. When the driver's hands are near or contacting steering wheel cover 110, the hands of the driver being present between first and second cover electrodes 11 and 12 and the vehicle chassis changes the electrostatic capacitance. If the detected electrostatic capacitance is greater than or equal to a prescribed value, it is possible to determine that the driver is contacting or gripping steering wheel cover 110 with his or her hand(s).

Moreover, grip detection processing section 35 outputs, independently of each other, a signal indicating a detection result according to the detection signal resulting from the detection by first cover electrode 11, and a signal indicating a detection result according to the detection signal resulting from the detection by second cover electrode 12. For example, grip detection processing section 35 inputs, into information processing device 80 and the like, a signal indicating a detection result from first cover electrode 11 indicating that the driver's hand is contacting steering wheel cover 110 and a signal indicating a detection result from second cover electrode 12 indicating that the driver's hand is contacting steering wheel cover 110.

Note that in the present embodiment, grip detection circuit 30 is exemplified as including grip detection processing section 35, but grip detection circuit 30 may further include first high pass filter 31 and second high pass filter 32.

### First Low Pass Filter 41 and Second Low Pass Filter 42

First low pass filter 41 is provided on wiring 91 that electrically connects first cover electrode 11 and multiplexer 60, and second low pass filter 42 is provided on wiring 91 that electrically connects second cover electrode 12 and multiplexer 60. First low pass filter 41 is electrically connected to first cover electrode 11 and electrically connected to multiplexer 60 via voltage follower circuit 50. Second low pass filter 42 is electrically connected to second cover electrode 12 and electrically connected to multiplexer 60 via voltage follower circuit 50.

First low pass filter 41 is a filter device that produces a detection signal of a predetermined frequency or lower by removing high frequency components of the detection signal from first cover electrode 11. Second low pass filter 42 is a filter device that produces a detection signal of a predetermined frequency or lower by removing high frequency components of the detection signal from second cover electrode 12. Each of first low pass filter 41 and second low pass filter 42 inputs a detection signal of a predetermined frequency or lower into multiplexer 60 via voltage follower circuit 50. Here, the predetermined frequency is, for example, 1 kHz, and is preferably 100 Hz.

### Voltage Follower Circuit 50

The plurality of voltage follower circuits 50 are disposed between first low pass filter 41 and multiplexer 60, second low pass filter 42 and multiplexer 60, first seat electrode 21 and multiplexer 60, and second seat electrode 22 and multiplexer 60. Voltage follower circuits 50 are provided on the output side of first low pass filter 41 on wiring 91, on the output side of second low pass filter 42 on wiring 91, on the output side of first seat electrode 21, and on the output side of second seat electrode 22. More specifically, first cover electrode 11 and second cover electrode 12 are electrically connected to the positive terminals of one of two sets of the plurality of voltage follower circuits 50 via first low pass filter 41, second low pass filter 42, and wiring 91, etc., and first seat electrode 21 and second seat electrode 22 are electrically connected to the positive terminals of the second of the two sets of the plurality of voltage follower circuits 50 via wiring 93. The negative terminal of each of the plurality of voltage follower circuits 50 receives an input of feedback from the output terminal of that voltage follower circuit 50. Each of the plurality of voltage follower circuits 50 is electrically connected to multiplexer 60, converts the output impedance of the detection signals from first cover electrode 11, second cover electrode 12, first seat electrode 21, and second seat electrode 22 to a low impedance, and inputs the low impedance detection signals into multiplexer 60.

Moreover, the wiring distances from voltage follower circuit 50 on the output side of first low pass filter 41 and first low pass filter 41 to first cover electrode 11 and the wiring distances from voltage follower circuit 50 on the output side of second low pass filter 42 and second low pass filter 42 to second cover electrode 12 are shorter than the wiring distances from first low pass filter 41 and the corresponding voltage follower circuit 50 to electrocardiographic detection circuit 70 and the wiring distances from second low pass filter 42 and the corresponding voltage follower circuit 50 to electrocardiographic detection circuit 70, respectively. In other words, on the wiring paths from first cover electrode 11 and second cover electrode 12 to multiplexer 60, first low pass filter 41 and second low pass filter 42 and the two corresponding voltage follower circuits 50 are disposed near first cover electrode 11 and second cover electrode 12 and far from electrocardiographic detection circuit 70.

For example, first low pass filter 41 and second low pass filter 42 and the two corresponding voltage follower circuits 50 may be distanced from first cover electrode 11 and second cover electrode 12 by a length that is less than half the wiring distance between first and second cover electrodes 11 and 12 and electrocardiographic detection circuit 70.

Moreover, the wiring distance from voltage follower circuit 50 on the output side of first seat electrode 21 to first seat electrode 21 is shorter than the wiring distance from said voltage follower circuit 50 to electrocardiographic detection circuit 70, and the wiring distance from voltage follower circuit 50 on the output side of second seat electrode 22 to second seat electrode 22 is shorter than the wiring distance from said voltage follower circuit 50 to electrocardiographic detection circuit 70. In other words, these two voltage follower circuits 50 are respectively disposed near first seat electrode 21 and second seat electrode 22 and far from electrocardiographic detection circuit 70.

For example, these two voltage follower circuits 50 may be distanced from first seat electrode 21 and second seat electrode 22 by a length that is less than half the wiring distance between first and second seat electrodes 21 and 22 and electrocardiographic detection circuit 70.

### Multiplexer 60

Multiplexer 60 is provided internally in driver's seat 203, for example. Multiplexer 60 is provided between (i) electrocardiographic detection circuit 70 and (ii) first low pass filter 41, second low pass filter 42, first seat electrode 21, and second seat electrode 22, and is electrically connected to electrocardiographic detection circuit 70 and the plurality of voltage follower circuits 50. Multiplexer 60 receives an input of a detection signal output from first cover electrode 11 via first low pass filter 41 and the like, an input of a detection signal output from second cover electrode 12 via second low pass filter 42 and the like, an input of a detection signal output from first seat electrode 21 via voltage follower circuit 50 and the like, and an input of a detection signal output from second seat electrode 22 via voltage follower circuit 50 and the like.

Multiplexer 60 is also electrically connected to control circuit 61. A switching signal is input into multiplexer 60 from control circuit 61. Multiplexer 60 is switched under control by the switching signal from control circuit 61 such that two of the four detection signals described above are selected. In other words, multiplexer 60 inputs, into electrocardiographic detection circuit 70, a set of two detection signals from two electrodes among the four electrodes of first cover electrode 11, second cover electrode 12, first seat electrode 21, and second seat electrode 22.

### Control Circuit 61

Control circuit 61 is provided internally in driver's seat 203, for example. Control circuit 61 sequentially switches multiplexer 60 so as to sequentially select all possible combinations of electrical connections between (i) any two of first cover electrode 11, second cover electrode 12, first seat electrode 21, and second seat electrode and (ii) electrocardiographic detection circuit 70. Stated differently, control circuit 61 controls multiplexer 60 so as to cause multiplexer 60 to output, from among all possible combinations of the four detection signals, two detection signals the combination of which has the greatest output width (amplitude).

More specifically, control circuit 61 selects all possible combinations of any two of the four detection signals obtained from first cover electrode 11, second cover electrode 12, first seat electrode 21, and second seat electrode 22, and from among the selected combinations, extracts the combination of detection signals from two electrodes whose output width is the greatest.

For example, control circuit 61 performs this extraction based on the detection result by electrocardiographic detection circuit 70. Control circuit 61 references all possible combinations of any two of the four detection signals obtained by multiplexer 60, and extracts the combination exhibiting the greatest potential difference between the two electrodes as indicated by the two detection signals in the combination.

Control circuit 61 outputs a switching signal that controls multiplexer 60 so as to extract the combination exhibiting the greatest potential difference between the two electrodes.

### Electrocardiographic Detection Circuit 70

Electrocardiographic detection circuit 70 is electrically connected to first cover electrode 11, second cover electrode 12, first seat electrode 21, and second seat electrode 22 via multiplexer 60 and the like. Two detection signals output from multiplexer 60 are input into electrocardiographic detection circuit 70. Electrocardiographic detection circuit 70 is an electrocardiograph that performs ECG waveform detection on the driver's body, based on two detection signals from among the detection signals from first cover electrode 11, second cover electrode 12, first seat electrode 21, and second seat electrode 22. Electrocardiographic detection circuit 70 is provided internally in driver's seat 203, for example.

Electrocardiographic detection circuit 70 includes amplification circuit 71 and A/D converter 72.

Amplification circuit 71 is electrically connected to multiplexer 60 and electrically connected to the input side of A/D converter 72. Amplification circuit 71 is a differential amplifier that amplifies the difference between the two detection signals input from multiplexer 60. More specifically, amplification circuit 71 generates a differential amplification signal (one example of the amplification signal) by amplifying, by the differential gain, a potential difference between the combination of the two electrodes combined by multiplexer 60. Amplification circuit 71 inputs the generated differential amplification signal into A/D converter 72.

A/D converter 72 is electrically connected to the output side of amplification circuit 71, and electrically connected to the input side of information processing device 80. A/D converter 72 converts the input differential amplification signal from analog to digital, and inputs the digital differential amplification signal into information processing device 80.

Note that in the present embodiment, electrocardiographic detection circuit 70 is exemplified as including amplification circuit 71 and A/D converter 72, but electrocardiographic detection circuit 70 may further include multiplexer 60, and may still further include the plurality of voltage follower circuits 50, and may yet further include first low pass filter 41 and second low pass filter 42.

### Information Processing Device 80

Information processing device 80 is a vehicle control unit, such as an electronic control unit (ECU) that performs integrated control of various parts of the vehicle, and is provided internally in driver's seat 203, for example. When information processing device 80 does not detect contact between the driver's hand and steering wheel cover 110 despite the fact that the vehicle is being driven by the driver, information processing device 80 causes the alerting device to alert the driver based on a detection result obtained from grip detection circuit 30 indicating that the driver's hand is contacting steering wheel cover 110. Cases in which contact is not detected between a hand and steering wheel cover 110 include, for example, cases in which the driver is not gripping steering wheel 200 with both hands simultaneously. For example, the alerting device alerts the driver via a warning sound or verbal warning, or displays a warning message that prompts the driver to firmly grip steering wheel 200 with both hands.

Moreover, information processing device 80 causes the alerting device to alert the driver when there is an anomaly in the ECG waveform as determined based on the differential amplification signal obtained from electrocardiographic detection circuit 70. For example, the alerting device alerts the driver via a warning sound or verbal warning, or displays a warning message that prompts the driver to firmly grip steering wheel 200 with both hands.

In this way, information processing device 80 includes driver monitoring functionality for estimating the physical and psychological states of the driver based on signals (biometric signals) indicating the detection results of grip detection circuit 30 and electrocardiographic detection circuit 70, and controlling the driving of the vehicle.

### Processing

In a state in which the driver is sitting in the driver's seat in the vehicle interior and gripping the steering wheel with both hands, with measurement device 1 according to the present embodiment, first cover electrode 11 and second cover electrode 12 in steering wheel cover 110 detect contact of steering wheel cover 110 by the driver's hand, and input detection signals resulting from the detection into first high pass filter 31, second high pass filter 32, first low pass filter 41, and second low pass filter 42. Moreover, first seat electrode 21 and second seat electrode 22 detect contact of the driver's seat by the driver's thigh, posterior, and back, and input detection signals resulting from the detection into voltage follower circuits 50 provided on wiring 93.

A detection signal resulting from the detection by first cover electrode 11 is input into first high pass filter 31, and a detection signal resulting from the detection by second cover electrode 12 is input into second high pass filter 32. Each of first high pass filter 31 and second high pass filter 32 removes low frequency components of the detection signal and inputs a detection signal of a predetermined frequency or higher into grip detection circuit 30.

Grip detection processing section 35 in grip detection circuit 30 detects whether the driver's hand contacted steering wheel cover 110 or not based on an amount of change in electrostatic capacitance between the driver's hand and first cover electrode 11 as indicated by the corresponding detection signal, as well as an amount of change in electrostatic capacitance between the driver's hand and second cover electrode 12 as indicated in the corresponding detection signal. For example, based on the individual detection results according to the detection signals resulting from the detection by first cover electrode 11 and second cover electrode 12, grip detection circuit 30 detects whether the driver is gripping steering wheel 200 with both hands simultaneously and outputs the detection result.

A detection signal resulting from the detection by first cover electrode 11 is input into first low pass filter 41, and a detection signal resulting from the detection by second cover electrode 12 is input into second low pass filter 42. Each of first low pass filter 41 and second low pass filter 42 removes high frequency components of the detection signal, and inputs a detection signal of a predetermined frequency or lower into the corresponding voltage follower circuit 50 provided on wiring 91.

Each voltage follower circuit 50 converts the output impedance of the detection signal to a low impedance, and inputs the low impedance detection signal into multiplexer 60. This reduces the influence of noise between the corresponding voltage follower circuits 50 and electrocardiographic detection circuit 70.

The switching of multiplexer 60 is controlled by control circuit 61 so that multiplexer 60 outputs two detection signals extracted from the four obtained detection signals. In other words, control circuit 61 controls the switching of multiplexer 60 by extracting the combination of the two electrodes (two detection signals) exhibiting the greatest potential difference, and inputting into multiplexer 60 a switching signal for causing multiplexer 60 to output the two detection signals. Multiplexer 60 inputs the two detection signals corresponding to the two electrodes exhibiting the greatest potential difference into electrocardiographic detection circuit 70.

Amplification circuit 71 in electrocardiographic detection circuit 70 amplifies the potential difference of the potentials indicated by the two detection signals output from multiplexer 60 by the differential gain. A/D converter 72 converts the amplified differential amplification signal to digital, and inputs the digital differential amplification signal into information processing device 80.

In this way, in measurement device 1 according to the present embodiment, grip detection and ECG waveform detection are performed by first cover electrode 11 and second cover electrode 12. Function and Advantages

Next, the function and advantages of measurement device 1 according to the present embodiment will be described.

As described above, with measurement device 1 according to the present embodiment, in a state in which the driver is sitting in driver's seat 203 and gripping steering wheel 200, grip detection circuit 30 receives, from first cover electrode 11 via first high pass filter 31, an input of a detection signal resulting from the gripping, and electrocardiographic detection circuit 70 receives, from first cover electrode 11 via first low pass filter 41, an input of a detection signal indicating an ECG waveform. Moreover, for example, electrocardiographic detection circuit 70 receives an input of a detection signal from second cover electrode 12 or first seat electrode 21, each of which is one example of the second electrode. Accordingly, grip detection circuit 30 can perform grip detection based on changes in electrostatic capacitance between first cover electrode 11 and the driver's hand, from the detection signal input via first high pass filter 31. Moreover, electrocardiographic detection circuit 70 can detect the ECG waveform of the driver from the potential difference between the potential of first cover electrode 11 and the potential of second cover electrode 12 or first seat electrode 21. Accordingly, the presence of dead regions in the grip detection and ECG waveform detection, and a reduction in electrode sensitivity, like is seen with conventional techniques, are less likely to occur.

Accordingly, the accuracy of the grip detection and the ECG waveform detection can be inhibited from decreasing.

In particular, as a result of each of first cover electrode 11 and second cover electrode 12 being used commonly as both an electrode for the ECG waveform detection and an electrode for the grip detection, the same electrode can be used to perform the grip detection and the ECG waveform detection. Accordingly, cases in which there is a region of steering wheel 200 in which grip of steering wheel 20 cannot be detected, and there is another region of steering wheel 20 in which an ECG waveform cannot be detected, that is to say, cases in which both the grip detection and the ECG waveform detection have dead regions, are unlikely. Consequently, grip detection and ECG waveform detection can be performed with certainty.

Moreover, with measurement device 1, since grip detection and ECG waveform detection need not be performed using respective electrodes, the manufacturing cost of measurement device 1 can be inhibited from steeply increasing.

Moreover, with measurement device 1, since an electrode for ECG waveform detection and an electrode for grip detection need not be wrapped around rim 201, steering wheel 200 can be inhibited from being difficult to grip due to an increase in the thickness of steering wheel cover 110.

Moreover, with measurement device 1 according to the present embodiment, providing first seat electrode 21 on front surface section 203a allows for the utilization of a part of the body that is characterized by a conductive path through the body—from the hand of the driver to the thigh of the driver—that is longer than the conductive path from the left hand of the driver to the right hand of the driver. In other words, the potential difference between the potential of first seat electrode 21 that detects one hand of the driver and the potential of first cover electrode 11 that detects the thigh of driver is greater than the potential difference between the potential of first seat electrode 21 when configured to detect the right hand of the driver and the potential of second seat electrode 22 when configured to detect the left hand of the driver. Consequently, with measurement device 1 according to the present embodiment, an ECG waveform can be measured more accurately.

Moreover, in measurement device 1 according to the present embodiment, second cover electrode 12 is provided in a different location on steering wheel 200 than first cover electrode 11. This makes it possible to determine whether both hands are gripping steering wheel 200 or not. For example, by determining whether the driver is appropriately gripping steering wheel 200 with both hands when control of the vehicle is handed over to the driver from a semiautonomous or autonomous driving state, the driver can be, for example, alerted to grip steering wheel 200 with both hands in order to improve the safety of the driver driving the vehicle.

Moreover, since measurement device 1 includes first seat electrode 21 as well, the potential difference between first cover electrode 11 or second cover electrode 12 that detects one hand and first seat electrode 21 that detects the thigh can be measured. Accordingly, measurement device 1 can measure an ECG waveform more accurately. In other words, measurement device 1 can improve the accuracy of grip detection and ECG waveform detection performed using both hands.

Moreover, with measurement device 1 according to the present embodiment, since grip detection circuit 30 outputs, independently of each other, a signal indicating a detection result according to the detection signal from first cover electrode 11 and a signal indicating a detection result according to the detection signal from second cover electrode 12, it is possible to detect whether steering wheel 200 is being gripped by both hands or not, as described above. Accordingly, with measurement device 1, the safety of the driver driving the vehicle can be further increased.

Moreover, with measurement device 1 according to the present embodiment, control circuit 61 switches multiplexer 60 so as to cause electrocardiographic detection circuit 70 to output a signal indicating detection results according to two of the four detection signals obtained from first cover electrode 11, second cover electrode 12, first seat electrode 21, and second seat electrode 22. Accordingly, control circuit 61 can cause multiplexer 60 to extract two of the four detection signals from first cover electrode 11, second cover electrode 12, first seat electrode 21, and second seat electrode 22 by switching multiplexer 60. Stated differently, since control circuit 61 can arbitrarily select two of the four electrodes, measurement device 1 can perform grip detection and ECG waveform detection suited to the driver's posture, for example.

Moreover, with measurement device 1 according to the present embodiment, by extracting, from among the four detection signals from the four electrodes—first cover electrode 11, second cover electrode 12, first seat electrode, 21, and second seat electrode 22—an optimal combination of two detection signals, that is, the combination that has the greatest output width, control circuit 61 can select the combination of the two electrodes that correspond to the two extracted detection signals. In other words, control circuit 61 can select the combination of the two electrodes that have the greatest potential difference. Accordingly, with measurement device 1, the accuracy of the ECG waveform detection can be increased with more certainty.

Moreover, with measurement device 1 according to the present embodiment, on the wiring path from first cover electrode 11 to electrocardiographic detection circuit 70 and on the wiring path from second cover electrode 12 or first seat electrode 21 to electrocardiographic detection circuit 70, first low pass filter 41 and each of voltage follower circuits 50 are disposed closer to these electrodes than electrocardiographic detection circuit 70. Among the wiring path from first cover electrode 11 to electrocardiographic detection circuit 70 and the wiring path from second cover electrode 12 or first seat electrode 21 to electrocardiographic detection circuit 70, each of voltage follower circuits 50 can convert the output impedance of the wiring paths to electrocardiographic detection circuit 70 to a low impedance. Accordingly, with measurement device 1, it is possible to inhibit the influence of noise on the wiring paths between voltage follower circuits 50 and electrocardiographic detection circuit 70.

### Variation of Embodiment 1

FIG. 3B is a block diagram of measurement device 1a according to a variation of Embodiment 1.

Unless otherwise stated, the configuration of measurement device 1a according to the present variation is the same as that of Embodiment 1. Moreover, same configurations share like reference signs, and repeated description thereof in detail will be omitted.

In FIG. 3A of Embodiment 1, voltage follower circuits 50 are respectively provided on the output sides of first low pass filter 41 and second low pass filter 42, but as illustrated in FIG. 3B, in the present variation , the output side of first low pass filter 41 and the output side of second low pass filter 42 are electrically connected.

As illustrated in FIG. 3B, in the present variation , the output of first low pass filter 41 and the output of second low pass filter 42 are combined (electrically connected together), and input into electrocardiographic detection circuit 70. More specifically, the detection signal output by first cover electrode 11 and the detection signal output by second cover electrode 12 are unified via first low pass filter 41 and second low pass filter 42 and input into a single voltage follower circuit 50. In other words, since the detection signals output from first low pass filter 41 and second low pass filter 42 become a single signal, first cover electrode 11 and second cover electrode 12 behave as a single electrode.

In this way, with measurement device 1a according to the present variation , the detection signal from first cover electrode 11 and the detection signal from second cover electrode 12 are combined and input into electrocardiographic detection circuit 70. Accordingly, first cover electrode 11 and second cover electrode 12 behave as a single electrode. This increases the surface area of the electrodes that oppose the hands of the driver, which increases the accuracy of the ECG waveform detection with more certainty.

Moreover, the present variation performs and achieves the same function and advantages as Embodiment 1.

### Embodiment 2

### Measurement Device 1b Configuration

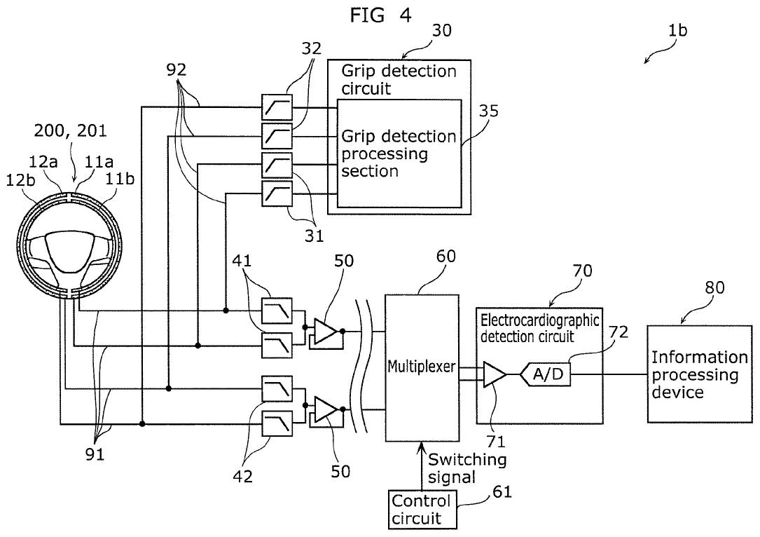

FIG. 4 is a block diagram of measurement device 1b according to Embodiment 2.

In FIG. 3A of Embodiment 1, steering wheel cover 110 includes first cover electrode 11 and second cover electrode 12, but as is illustrated in FIG. 4, with measurement device 1b according to the present embodiment, the first cover electrode is split into two first cover electrodes 11a and 11b, and the second cover electrode is split into two second cover electrodes 12a and 12b so that measurement device 1b includes four cover electrodes. Accordingly, in the present embodiment, a pair of first high pass filters 31 and a pair of first low pass filters 41 are electrically connected to the output sides of the pair of first cover electrodes 11a ad 11b, and a pair of second high pass filters 32 and a pair of second low pass filters 42 are electrically connected to the output sides of the pair of second cover electrodes 12a and 12b.

Moreover, although first seat electrode 21 and second seat electrode 22 are not provided in measurement device 1b according to the present embodiment, first seat electrode 21 and second seat electrode 22 that are electrically connected to electrocardiographic detection circuit 70 like in FIG. 3A of Embodiment 1 may be provided in measurement device 1b according to the present embodiment. In the present embodiment, the pair of first cover electrodes 11a and 11b is one example of the first electrode, and the pair of second cover electrodes 12a and 12b is one example of the second electrode.

Unless otherwise stated, the configuration of measurement device 1b according to the present embodiment is the same as that of Embodiment 1. Moreover, same configurations share like reference signs, and repeated description thereof in detail will be omitted.

As illustrated in FIG. 4, the pair of first cover electrodes 11a and 11b are provided on one side (for example, the right side) of rim 201, along the circumferential direction of rim 201. Among the pair of first cover electrodes 11a and 11b, first cover electrode lib is provided on the inner circumferential side of rim 201, and first cover electrode 11a is provided on the outer circumferential side of rim 201.

The pair of second cover electrodes 12a and 12b are provided on the other side (for example, the left side) of rim 201, along the circumferential direction of rim 201. Among the pair of second cover electrodes 12a and 12b, second cover electrode 12b is provided on the inner circumferential side of rim 201, and second cover electrode 12a is provided on the outer circumferential side of rim 201.

Note that the arrangement of the pair of first cover electrodes 11a and 11b and the pair of second cover electrodes 12a and 12b is not limited to the above example. For example, the pair of first cover electrodes and the pair of second cover electrodes may each have an arc shape formed by dividing a circle radially into four arcs, and be aligned along the circumference direction of rim 201. More specifically, one first cover electrode may be provided on the top half of one side of rim 201, the other first cover electrode may be provided on the bottom half of the that side of rim 201, one second cover electrode may be provided on the top half of the other side of rim 201, and the other second cover electrode may be provided on the bottom half of that side of rim 201.

Since the outputs of the pair of first low pass filters 41 are electrically connected, the detection signals output by the pair of first cover electrodes 11a and lib are unified via the pair of first low pass filters 41 and input into a single voltage follower circuit 50. In other words, since the detection signals output from the pair of first low pass filters 41 become a single signal, the pair of first cover electrodes 11a and 11b behave as a single electrode.

Moreover, since the outputs of the pair of second low pass filters 42 are electrically connected, the detection signals output by the pair of second cover electrodes 12a and 12b are unified via the pair of second low pass filters 42 and input into a single voltage follower circuit 50. In other words, since the detection signals output from the pair of second low pass filters 42 become a single signal, the pair of second cover electrodes 12a and 12b behave as a single electrode. Function and Advantages

Next, the function and advantages of measurement device 1b according to the present embodiment will be described.

As described above, with measurement device 1b according to the present embodiment, a pair of first cover electrodes 11a and 11b that are electrically connected to first low pass filter 41 are provided on steering wheel 200, and a pair of second cover electrodes 12a and 12b that are electrically connected to second low pass filter 42 are provided on steering wheel 200. Since providing a pair of first cover electrodes 11a and lib and a pair of second cover electrodes 12a and 12b on steering wheel 200 allows for both grip detection and ECG waveform detection to be performed, the installment of measurement device 1b is simplified.

Moreover, with measurement device 1b according to the present embodiment, since grip detection circuit 30 outputs, independently of each other, signals indicating detection results according to the detection signals from the pair of first cover electrodes 11a and lib and signals indicating detection results according to the detection signals from the pair of second cover electrodes 12a and 12b, it is possible to detect whether steering wheel 200 is being gripped by both hands or not, as described above. Accordingly, with measurement device 1b, the safety of the driver driving the vehicle can be further increased.

Moreover, the present embodiment performs and achieves the same function and advantages as Embodiment 1.

### Embodiment 3

### Measurement Device 1c Configuration

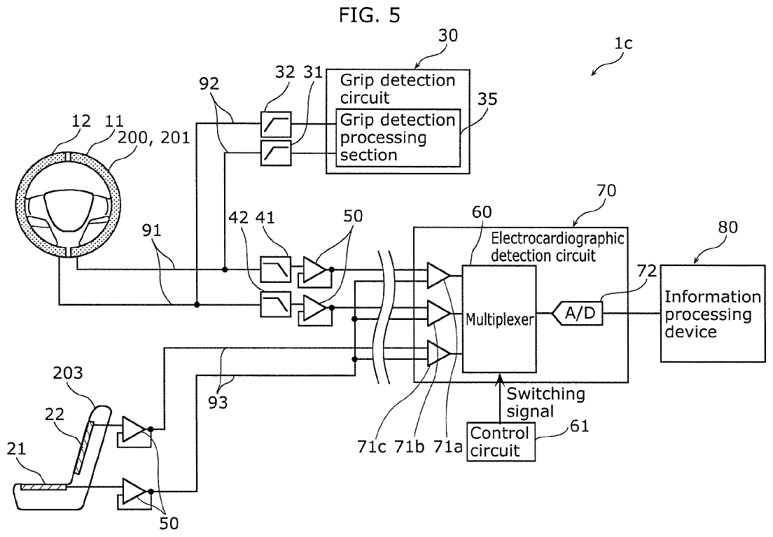

FIG. 5 is a block diagram of measurement device is according to Embodiment 3.

In FIG. 3A of Embodiment 1, multiplexer 60 is provided between amplification circuit 71 and voltage follower circuit 50, but as is illustrated in FIG. 5, in the present embodiment, multiplexer 60 is provided between a plurality of amplification circuits and A/D converter 72.

Unless otherwise stated, the configuration of measurement device 1c according to the present embodiment is the same as that of Embodiment 1. Moreover, same configurations share like reference signs, and repeated description thereof in detail will be omitted.

As illustrated in FIG. 5, electrocardiographic detection circuit 70 includes a plurality of amplification circuits. In the present embodiment, measurement device 1c is exemplified as including three amplification circuits—namely first amplification circuit 71a, second amplification circuit 71b, and third amplification circuit 71c—but the number of amplification circuits changes according to the number of electrodes, so four or more amplification circuits may be used, and two amplification circuits may be used. Moreover, two amplification circuits among first amplification circuit 71a, second amplification circuit 71b, and third amplification circuit 71c are examples of the first amplification circuit and the second amplification circuit, respectively.

Each of the amplification circuits in electrocardiographic detection circuit 70 is electrically connected to two of the plurality of voltage follower circuits 50. More specifically, all amplification circuits are electrically connected to voltage follower circuit 50 that corresponds to first seat electrode 21. Moreover, voltage follower circuits 50 that correspond to second seat electrode 22, first cover electrode 11, and second cover electrode 12 are electrically connected to the plurality of amplification circuits in one to one correspondence. In the present embodiment, first seat electrode 21 is set as a reference potential electrode. More specifically, the input side of first amplification circuit 71a is electrically connected to first low pass filter 41 and first seat electrode 21 via the corresponding voltage follower circuits 50, and the output side of first amplification circuit 71a is electrically connected to multiplexer 60. The input side of second amplification circuit 71b is electrically connected to second low pass filter 42 and first seat electrode 21 via the corresponding voltage follower circuits 50, and the output side of second amplification circuit 71b is electrically connected to multiplexer 60. The input side of third amplification circuit 71c is electrically connected to first seat electrode 21 and second seat electrode 22 via the corresponding voltage follower circuits 50, and the output side of third amplification circuit 71c is electrically connected to multiplexer 60.

Each of first amplification circuit 71a, second amplification circuit 71b, and third amplification circuit 71c inputs, into multiplexer 60, a differential amplification signal obtained by differential amplification of the low impedance detection signals output from the corresponding voltage follower circuits 50.

In the present embodiment, electrocardiographic detection circuit 70 includes multiplexer 60. Multiplexer 60 inputs one of the plurality of obtained differential amplification signals into A/D converter 72. More specifically, under control by control circuit 61, multiplexer 60 is switched so as to select the differential amplification signal exhibiting the greatest potential difference among the plurality of differential amplification signals.

### Function and Advantages

Next, the function and advantages of measurement device is according to the present embodiment will be described.

As described above, in measurement device 1c according to the present embodiment, control circuit 61 switches multiplexer 60 so that (i) any one of first cover electrode 11, second cover electrode 12, and second seat electrode 22, (ii) first seat electrode 21, and (iii) electrocardiographic detection circuit 70 are electrically connected. Accordingly, as a result of control circuit 61 switching multiplexer 60, it is possible to select a given potential difference from among three potential differences—namely the potential difference between the potential of first cover electrode 11 and the potential of first seat electrode 21, the potential difference between the potential of second cover electrode 12 and the potential of first seat electrode 21, and the potential difference between the potential of second seat electrode 22 and the potential of first seat electrode 21. In other words, control circuit 61 causes multiplexer 60 to extract one differential amplification signal from among the differential amplification signals output from first amplification circuit 71a, second amplification circuit 71b, and third amplification circuit 71c. As a result, control circuit 61 can select an appropriate differential amplification signal from among a plurality of differential amplification signals, whereby measurement device 1c can further improve the accuracy of the grip detection and the ECG waveform detection.

Moreover, the present embodiment performs and achieves the same function and advantages as Embodiment 1 and the like.

### Embodiment 4

### Measurement Device 2 Configuration

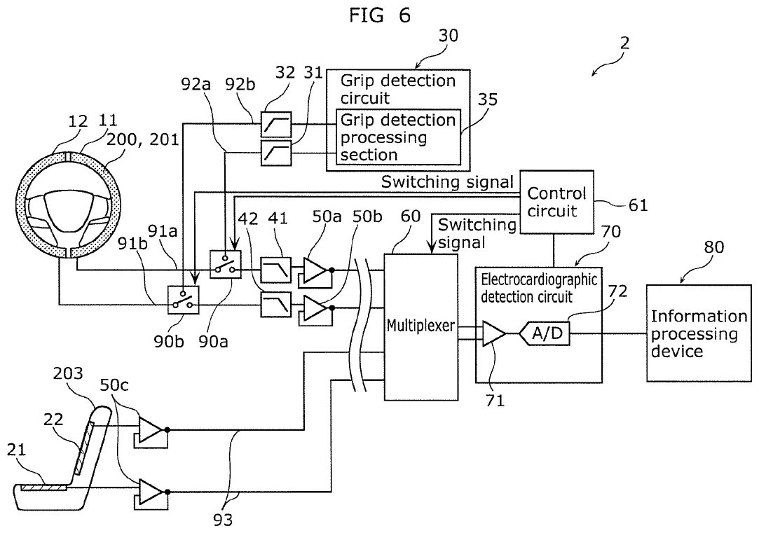

FIG. 6 is a block diagram of measurement device 2 according to Embodiment 4.

As illustrated in FIG. 6 of Embodiment 4, measurement device 2 differs from Embodiment 1 and the like in regard to the inclusion of first selector 90a and second selector 90b.

Unless otherwise stated, the configuration of measurement device 2 according to the present embodiment is the same as that of Embodiment 1 and the like. Moreover, same configurations share like reference signs, and repeated description thereof in detail will be omitted.

Measurement device 2 includes first selector 90a and second selector 90b in addition to first cover electrode 11, second cover electrode 12, first seat electrode 21, second seat electrode 22, first high pass filter 31, second high pass filter 32, grip detection circuit 30, first low pass filter 41, second low pass filter 42, first voltage follower circuit 50a, second voltage follower circuit 50b, third voltage follower circuit 50c, multiplexer 60, control circuit 61, electrocardiographic detection circuit 70, and information processing device 80. Note that hereinafter, when the plain terminology “voltage follower circuit” is used, this collectively refers to first voltage follower circuit 50a, second voltage follower circuit 50b, and third voltage follower circuit 50c.

### First Cover Electrode 11 and Second Cover Electrode 12

First cover electrode 11 is electrically connected to first high pass filter 31 and via wiring 91a and 92a, and second cover electrode 12 is electrically connected to second high pass filter 32 via wiring 91b and 92b. Wiring 92a is electrically connected to wiring 91a, and wiring 92b is electrically connected to wiring 91b. Moreover, wiring 92a and 92b branch from wiring 91a and 91b, respectively.

First cover electrode 11 and second cover electrode 12 are electrically connected to first low pass filter 41 and second low pass filter 42 via wiring 90a and 90b, respectively. When contact of steering wheel cover 110 by the driver's hand is detected, first cover electrode 11 inputs a detection signal into first high pass filter 31 or first low pass filter 41 as a result of being switched by first selector 90a (to be described later), and second cover electrode 12 inputs a detection signal into second high pass filter 32 or second low pass filter 42 as a result of being switched by second selector 90b (to be described later) at approximately the same timing as the switching by first selector 90a.

### First High Pass Filter 31 and Second High Pass Filter 32

First high pass filter 31 is provided on wiring 91a and 92a (on wiring 92a in the present embodiment) that electrically connect first cover electrode 11 and grip detection circuit 30, and second high pass filter 32 is a filter different from first high pass filter 31 that is provided on wiring 91b and 92b (wiring 92b in the present embodiment) that electrically connect second cover electrode 12 and grip detection circuit 30. First high pass filter 31 and second high pass filter 32 are electrically connected to grip detection processing section 35 via wiring 92a and 92b, respectively.

### First Selector 90a and Second Selector 90b

First selector 90a is provided between first cover electrode 11 and first high pass filter 31, and between first cover electrode 11 and first low pass filter 41. Second selector 90b is provided between second cover electrode 12 and second high pass filter 32, and between second cover electrode 12 and second low pass filter 42.

First selector 90a is provided on wiring 91a, at the connection point (branching point) of wiring 91a and wiring 92a, and is electrically connected to first low pass filter 41 and first cover electrode 11 via wiring 91a and electrically connected to first high pass filter 31 via wiring 92a. Second selector 90b is provided on wiring 91b, at the connection point (branching point) of wiring 91b and wiring 92b, and is electrically connected to second low pass filter 42 and second cover electrode 12 via wiring 91b and electrically connected to second high pass filter 32 via wiring 92b.

Moreover, first selector 90a and second selector 90b are electrically connected to control circuit 61. First selector 90a and second selector 90b receive inputs of switching signals from control circuit 61. First selector 90a is a switch that is switched under control by the switching signal from control circuit 61 so as to select either electrical connection with first low pass filter 41 or electrical connection with first high pass filter 31. Second selector 90b is a switch that is switched under control by the switching signal from control circuit 61 so as to select, in synchronization with first selector 90a, either electrical connection with second low pass filter 42 or electrical connection with second high pass filter 32. Note that the switching may be controlled so that electrical connection with first low pass filter 41 and electrical connection with first high pass filter 31 are switched alternately, and switching may be controlled so that electrical connection with second low pass filter 42 and electrical connection with second high pass filter 32 are switched alternately.

More specifically, first selector 90a switches from electrical connection with first low pass filter 41 to electrical connection with first high pass filter 31 at the same time as the switching of electrical connection with second low pass filter 42 to electrical connection with second high pass filter 32 by second selector 90b. With this, first cover electrode 11 is electrically connected to first high pass filter 31 via first selector 90a, and second cover electrode 12 is electrically connected to second high pass filter 32 via second selector 90b. Moreover, first selector 90a switches from electrical connection with first high pass filter 31 to electrical connection with first low pass filter 41 at the same time as the switching of electrical connection with second high pass filter 32 to electrical connection with second low pass filter 42 by second selector 90b. With this, first cover electrode 11 is electrically connected to first low pass filter 41 via first selector 90a, and second cover electrode 12 is electrically connected to second low pass filter 42 via second selector 90b.

Moreover, first selector 90a selects first high pass filter 31 for a predetermined period, and second selector 90b selects second high pass filter 32 for a predetermined period. Since the heartbeat based on the ECG waveform is the pulsing of the heart that occurs in a regular cycle, the predetermined period is at least part of the period between two adjacent pulses (for example, the periods known as the SQ interval, the RQ interval, the SR interval, etc., in an electrocardiogram wave form). The predetermined period and the period other than the predetermined period alternately repeat in accordance with the pulse of the heart. As used herein, “pulse” may refer to the R wave, the Q wave, or the S wave in an electrocardiogram. Moreover, since first selector 90a is in synchronization with second selector 90b, the predetermined period of first selector 90a is at approximately the same timing as the predetermined period of second selector 90b.

In the predetermined period, first selector 90a selects first high pass filter 31 to electrically connect first cover electrode 11 and first high pass filter 31, and in the period other than the predetermined period, first selector 90a selects first low pass filter 41 to electrically connect first cover electrode 11 and first low pass filter 41. Moreover, in the predetermined period, second selector 90b selects second high pass filter 32 to electrically connect second cover electrode 12 and second high pass filter 32, and in the period other than the predetermined period, second selector 90b selects second low pass filter 42 to electrically connect second cover electrode 12 and second low pass filter 42. Here, the period other than the predetermined period is the period in which the pulse of the heart is detected, and includes, for example, periods known as the QRS complex, the QR segment, the RS segment, or the R segment in an electrocardiogram.

Note that the period other than the predetermined period in which first selector 90a and second selector 90b select first low pass filter 41 and second low pass filter 42, respectively, is longer than the predetermined period in which first selector 90a and second selector 90b select first high pass filter 31 and second high pass filter 32, respectively. For example, the period other than the predetermined period in which first selector 90a and second selector 90b select first low pass filter 41 and second low pass filter 42, respectively, is approximately 10 times longer than the predetermined period in which first selector 90a and second selector 90b select first high pass filter 31 and second high pass filter 32, respectively.

### First Low Pass Filter 41 and Second Low Pass Filter 42

First low pass filter 41 is provided on wiring 91a that electrically connects first cover electrode 11 and multiplexer 60, and second low pass filter 42 is provided on wiring 91b that electrically connects second cover electrode 12 and multiplexer 60. First low pass filter 41 is electrically connected to first cover electrode 11 and electrically connected to multiplexer 60 via first voltage follower circuit 50a. Second low pass filter 42 is electrically connected to second cover electrode 12 and electrically connected to multiplexer 60 via second voltage follower circuit 50b.

### Voltage Follower Circuit

The plurality of voltage follower circuits are disposed between first low pass filter 41 and multiplexer 60, second low pass filter 42 and multiplexer 60, first seat electrode 21 and multiplexer 60, and second seat electrode 22 and multiplexer 60. Among the plurality of voltage follower circuits, first voltage follower circuit 50a and second voltage follower circuit 50b are provided on the output side of first low pass filter 41 on wiring 91a and on the output side of second low pass filter 42 on wiring 91b, respectively, and third voltage follower circuits 50c are provided on the output side of first seat electrode 21 and the output side of second seat electrode 22. More specifically, among the plurality of voltage follower circuits, first cover electrode 11 and second cover electrode 12 are electrically connected to the positive side input terminals of first voltage follower circuit 50a and second voltage follower circuit 50b, respectively, via first low pass filter 41, second low pass filter 42, wiring 91a, wiring 91b, etc. Moreover, first seat electrode 21 and second seat electrode 22 are electrically connected to the positive side input terminals of third voltage follower circuits 50c via wiring 93.

Moreover, the wiring distance from first voltage follower circuit 50a on the output side of first low pass filter 41 to first cover electrode 11, the wiring distance from first low pass filter 41 to first cover electrode 11, the wiring distance from second voltage follower circuit 50b on the output side of second low pass filter 42 to second cover electrode 12, and the wiring distance from second low pass filter 42 to second cover electrode 12 are each shorter than each of the wiring distance from first low pass filter 41 to electrocardiographic detection circuit 70, the wiring distance from second low pass filter 42 to electrocardiographic detection circuit 70, the wiring distance from first voltage follower circuit 50a to electrocardiographic detection circuit 70, and the wiring distance from second voltage follower circuit 50b to electrocardiographic detection circuit 70. In other words, on the wiring paths from first cover electrode 11 and second cover electrode 12 to multiplexer 60, first low pass filter 41 and second low pass filter 42 and the corresponding first and second voltage follower circuits 50a and 50b are disposed near first cover electrode 11 and second cover electrode 12 and far from electrocardiographic detection circuit 70.

For example, first low pass filter 41 and second low pass filter 42 and the corresponding first and second voltage follower circuits 50a and 50b may be distanced from first cover electrode 11 and second cover electrode 12 by a length that is less than half the wiring distance between first and second cover electrodes 11 and 12 and electrocardiographic detection circuit 70.

Moreover, the wiring distance from first voltage follower circuit 50a on the output side of first seat electrode 21 to first seat electrode 21 is shorter than the wiring distance from first voltage follower circuit 50a to electrocardiographic detection circuit 70, and the wiring distance from second voltage follower circuit 50b on the output side of second seat electrode 22 to second seat electrode 22 is shorter than the wiring distance from second voltage follower circuit 50b to electrocardiographic detection circuit 70. In other words, first voltage follower circuit 50a and second voltage follower circuit 50b are respectively disposed near first seat electrode 21 and second seat electrode 22 and far from electrocardiographic detection circuit 70.

For example, first voltage follower circuit 50a and second voltage follower circuit 50b may be distanced from first seat electrode 21 and second seat electrode 22 by a length that is less than half the wiring distance between first and second seat electrodes 21 and 22 and electrocardiographic detection circuit 70.

### Control Circuit 61

Control circuit 61 is provided internally in driver's seat 203, for example. Control circuit 61 sequentially switches multiplexer 60 so as to sequentially select all possible combinations of electrical connections between (i) any two of first cover electrode 11, second cover electrode 12, first seat electrode 21, and second seat electrode 22 and (ii) electrocardiographic detection circuit 70. Stated differently, when first selector 90a selects first low pass filter 41 and second selector 90b selects second low pass filter 42, control circuit 61 controls multiplexer 60 so as to cause multiplexer 60 to output, from among all possible combinations of the four detection signals, detection signals whose output width (amplitude) is a maximum of two detection signals (a combination of a maximum of two detection signals).

More specifically, when first low pass filter 41 and second low pass filter 42 are selected, control circuit 61 selects all possible combinations of any two of the four detection signals obtained from first cover electrode 11, second cover electrode 12, first seat electrode 21, and second seat electrode 22, and from among the selected combinations, extracts a combination of detection signals from two electrodes whose output width is the greatest.

For example, control circuit 61 performs this extraction based on the detection result by electrocardiographic detection circuit 70. When first low pass filter 41 and second low pass filter 42 are selected, control circuit 61 references all possible combinations of any two of the four detection signals obtained by multiplexer 60, and extracts a combination exhibiting the greatest potential difference between the two electrodes as indicated by the two detection signals in the combination.

When first low pass filter 41 and second low pass filter 42 are selected, control circuit 61 outputs a switching signal that controls multiplexer 60 to extract the combination exhibiting the greatest potential difference between the two electrodes.

Moreover, control circuit 61 obtains an electrocardiographic detection signal indicating the detection result of the ECG waveform detection performed on the driver from electrocardiographic detection circuit 70. Control circuit 61 determines whether the amplitude of the ECG waveform indicated by the electrocardiographic detection signal is less than a predetermined value or not. When the amplitude of the ECG waveform is greater than or equal to the predetermined value, control circuit 61 outputs switching signals to first selector 90a and second selector 90b that cause first selector 90a to switch from first high pass filter 31 to first low pass filter 41 (i.e., select first low pass filter 41) and cause second selector 90b to switch from second high pass filter 32 to second low pass filter 42 (i.e., select second low pass filter 42). When the amplitude of the ECG waveform is less than the predetermined value, control circuit 61 outputs switching signals to first selector 90a and second selector 90b that cause first selector 90a to switch from first low pass filter 41 to first high pass filter 31 (i.e., select first high pass filter 31) and cause second selector 90b to switch from second low pass filter 42 to second high pass filter 32 (i.e., select second high pass filter 32).

Moreover, control circuit 61 calculates the period in which there is a pulse of the heart as indicated by the electrocardiographic detection signal and the period between two adjacent pulses, and controls first selector 90a and second selector 90b. In other words, in order for control circuit 61 to electrically connect first high pass filter 31 and first cover electrode 11 in the predetermined period, which is at least part of the period between two adjacent pulses, control circuit 61 outputs a switching signal to first selector 90a to control first selector 90a, and outputs a switching signal to second selector 90b to control second selector 90b in order to electrically connect second high pass filter 32 and second cover electrode 12. Moreover, in order for control circuit 61 to electrically connect first low pass filter 41 and first cover electrode 11 in the period other than the predetermined period, control circuit 61 outputs a switching signal to first selector 90a to control first selector 90a, and outputs a switching signal to second selector 90b to control second selector 90b in order to electrically connect second low pass filter 42 and second cover electrode 12.

Note that in the present embodiment, control circuit 61 is exemplified as including functionality for switching first selector 90a and second selector 90b, as described above, each of first selector 90a and second selector 90b may switch between functioning as a low pass filter and a high pass filter based on electrocardiographic detection signals. In such cases, each of first selector 90a and second selector 90b may obtain the electrocardiographic detection signals from electrocardiographic detection circuit 70.

### Processing

In a state in which the driver is sitting in the driver's seat in the vehicle interior and gripping the steering wheel with both hands, in measurement device 2 according to the present embodiment, first cover electrode 11 and second cover electrode 12 in steering wheel cover 110 detect contact of steering wheel cover 110 by the driver's hand, and input detection signals resulting from the detection are input by first selector 90a and second selector 90b selecting first high pass filter 31 and second high pass filter 32, and input by first selector 90a and second selector 90b selecting first low pass filter 41 and second low pass filter 42. Moreover, first seat electrode 21 and second seat electrode 22 detect contact of the driver's seat by the driver's thigh, posterior, and back, and input detection signals resulting from the detection into third voltage follower circuits 50c provided on wiring 93.

Depending on the selections by first selector 90a and second selector 90b, a detection signal resulting from the detection by first cover electrode 11 is input into first high pass filter 31, and a detection signal resulting from the detection by second cover electrode 12 is input into second high pass filter 32. Each of first high pass filter 31 and second high pass filter 32 removes low frequency components of the detection signal and inputs a detection signal of a predetermined frequency or higher into grip detection circuit 30.

Depending on the selections by first selector 90a and second selector 90b, a detection signal resulting from the detection by first cover electrode 11 is input into first low pass filter 41, and a detection signal resulting from the detection by second cover electrode 12 is input into second low pass filter 42. Each of first low pass filter 41 and second low pass filter 42 removes high frequency components of the detection signal, and inputs a detection signal of a predetermined frequency or lower into first voltage follower circuit 50a on wiring 91a and second voltage follower circuit 50b on wiring 91b.

The switching of multiplexer 60 is controlled by control circuit 61 so that multiplexer 60 outputs two detection signals extracted from the four obtained detection signals. In other words, when first low pass filter 41 and second low pass filter 42 are selected, control circuit controls the switching of multiplexer 60 by extracting the combination of the two electrodes (two detection signals) exhibiting the greatest potential difference, and inputting into multiplexer 60 a switching signal for causing multiplexer 60 to output the two detection signals. Multiplexer 60 inputs the two detection signals corresponding to the two electrodes exhibiting the greatest potential difference into electrocardiographic detection circuit 70.

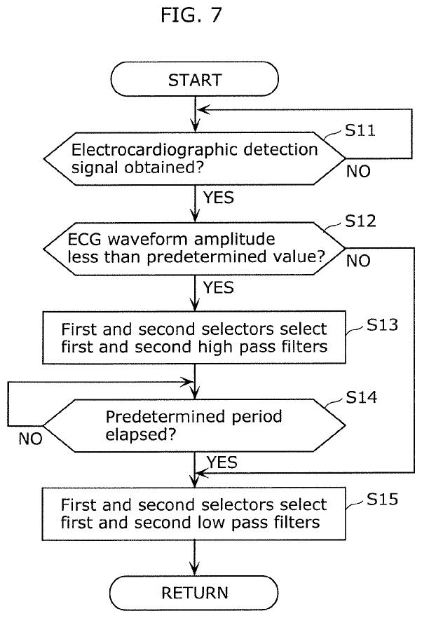

Next, processes performed by control circuit 61 will be described with reference to FIG. 7.

FIG. 7 is a flow chart of processes performed by measurement device 2 according to Embodiment 4. Note that in FIG. 7, the control processing performed by first selector 90a and second selector 90b in particular will be described. Moreover, the detections by grip detection circuit 30 and electrocardiographic detection circuit 70 are performed after the selection control by first selector 90a and second selector 90b (i.e., after S13 and S15 in FIG. 7 (to be described later)).

First, control circuit 61 determines whether an electrocardiographic detection signal has been obtained from electrocardiographic detection circuit 70 or not. When control circuit 61 determines that an electrocardiographic detection signal has not been obtained from electrocardiographic detection circuit 70 (NO in S11), processing returns to step S11, and the same process is repeated.

When control circuit 61 determines that an electrocardiographic detection signal has been obtained from electrocardiographic detection circuit 70 (YES in S11), control circuit 61 determines whether the amplitude of the ECG waveform indicated by the electrocardiographic detection signal is less than a predetermined value.

When the amplitude of the ECG waveform is greater than or equal to the predetermined value (NO in S12), control circuit 61 outputs switching signals to first selector 90a and second selector 90b. In other words, when the amplitude of the ECG waveform is greater than or equal to the predetermined value, this indicates the period other than the predetermined period in which the heart pulses. Accordingly, control circuit 61 outputs a switching signal to first selector 90a that causes first selector 90a to switch from first high pass filter 31 to first low pass filter 41 (i.e., select first low pass filter 41) (S15). Consequently, first low pass filter 41 and first cover electrode 11 become electrically connected. Control circuit 61 moreover outputs a switching signal to second selector 90b that causes second selector 90b to switch from second high pass filter 32 to second low pass filter 42 (i.e., select second low pass filter 42) (S15). Consequently, second low pass filter 42 and second cover electrode 12 become electrically connected. Electrocardiographic detection circuit 70 obtains, from multiplexer 60, two of the four detection signals from first cover electrode 11, second cover electrode 12, first seat electrode 21, and second seat electrode 22. Note that the predetermined value may be set as a threshold that allows for detection of an S wave in an electrocardiogram.

Thereafter, control circuit 61 repeats these processes each time an electrocardiographic detection signal is obtained.

When the amplitude of the ECG waveform is less than the predetermined value (YES in S12), control circuit 61 outputs switching signals to first selector 90a and second selector 90b. In other words, when the amplitude of the ECG waveform is less than the predetermined value, this indicates the predetermined period in which the heart does not pulse. Note that the predetermined period is obtained from the electrocardiograph detected immediately previously, and is updated as a period between two pulses. Accordingly, control circuit 61 outputs a switching signal to first selector 90a that causes first selector 90a to switch from first low pass filter 41 to first high pass filter 31 (i.e., select first high pass filter 31) (S13). Consequently, first high pass filter 31 and first cover electrode 11 become electrically connected. Control circuit 61 moreover outputs a switching signal to second selector 90b that causes second selector 90b to switch from second low pass filter 42 to second high pass filter 32 (i.e., select second high pass filter 32) (S13). Consequently, second high pass filter 32 and second cover electrode 12 become electrically connected. As a result, grip detection circuit 30 obtains the detection signals from first cover electrode 11 and second cover electrode 12.

Control circuit 61 determines whether the predetermined period has elapsed or not after outputting the switching signals, that is to say, after first selector 90a and second selector 90b select first high pass filter 31 and second high pass filter 32 (S14). If the predetermined period has not elapsed (NO in S14), control circuit 61 repeats this process until the predetermined period elapses.

If the predetermined period has elapsed (YES in S14), control circuit 61 causes first selector 90a and second selector 90b to select first low pass filter 41 and second low pass filter 42 (S15).

Thereafter, control circuit 61 repeats these processes each time an electrocardiographic detection signal is obtained.

### Function and Advantages

Next, the function and advantages of measurement device 2 according to the present embodiment will be described.

As described above, with measurement device 2 according to the present embodiment, in a state in which the driver is sitting in driver's seat 203 and gripping steering wheel 200, as a result of first selector 90a being configured to select first low pass filter 41 and configured to select first high pass filter 31, there are instances in which the detection signal from first cover electrode 11 is input into grip detection circuit 30 via first high pass filter 31, and there are instances in which the detection signal from first cover electrode 11 is input into electrocardiographic detection circuit 70 via first low pass filter 41. Moreover, for example, electrocardiographic detection circuit 70 receives an input of a detection signal from second cover electrode 12 or first seat electrode 21, each of which is one example of the second electrode. Accordingly, grip detection circuit 30 can perform grip detection based on changes in electrostatic capacitance between first cover electrode 11 and the driver's hand, from the detection signal input via first high pass filter 31. Moreover, electrocardiographic detection circuit 70 can detect the ECG waveform of the driver from the potential difference between the potential of first cover electrode 11 and the potential of second cover electrode 12 or first seat electrode 21. Accordingly, the presence of dead regions in the grip detection and ECG waveform detection, and a reduction in electrode sensitivity, like is seen with conventional techniques, are less likely to occur.

Accordingly, the accuracy of the grip detection and the ECG waveform detection can be inhibited from decreasing.

In particular, first cover electrode 11 does not concurrently connect to first low pass filter 41 and first high pass filter 31 by first selector 90a, that is to say, grip detection circuit 30 and electrocardiographic detection circuit 70 are not concurrently connected. Accordingly, noise superimposed on electrocardiographic detection circuit 70 is blocked by first selector 90a, inhibiting propagation to grip detection circuit 30. Accordingly, with measurement device 2, the accuracy of the grip detection by grip detection circuit 30 can be increased.

Moreover, as a result of each of first cover electrode 11 and second cover electrode 12 being used commonly as both an electrode for the ECG waveform detection and an electrode for the grip detection, the same electrode can be used to perform the grip detection and the ECG waveform detection. Accordingly, cases in which loss of detection of a grip on steering wheel 200 occurs in one region and loss of ECG waveform detection occurs in another region, that is to say, cases in which dead regions are present in both regions is unlikely. Consequently, grip detection and ECG waveform detection can be performed with certainty.

Moreover, with measurement device 2, since grip detection and ECG waveform detection need not be performed using respective electrodes, the manufacturing cost of measurement device 2 can be inhibited from steeply increasing and the structure of measurement device 2 can be kept from becoming overly complicated.

Moreover, with measurement device 2, since an electrode for ECG waveform detection and an electrode for grip detection need not be wrapped around rim 201, steering wheel 200 can be inhibited from being difficult to grip due to an increase in the thickness of steering wheel cover 110.

For example, since the heartbeat based on the ECG waveform is the pulsing of the heart that occurs in a regular cycle, the interval between pulses, that is to say, the period between two adjacent pulses is the predetermined period in which the heartbeat is not detected.

Moreover, with measurement device 2 according to the present embodiment, in the predetermined period in which the amplitude of the ECG waveform is less than the predetermined value, first selector 90a selects first high pass filter 31 and second selector 90b selects second high pass filter 32. In the period other than the predetermined period, first selector 90a selects first low pass filter 41 and second selector 90b selects second low pass filter 42. Accordingly, with measurement device 2, since the grip detection and the ECG waveform detection can be performed as a result of the predetermined period and the period other than the predetermined period repeating in a cycle, like the ECG waveform does, it is possible to ensure that the grip detection and the ECG waveform detection are performed.

Moreover, with measurement device 2 according to the present embodiment, providing first seat electrode 21 on front surface section 203a allows for the utilization of a part of the body that is characterized by a conductive path through the body—from the hand of the driver to the thigh of the driver—that is longer than the conductive path from the left hand of the driver to the right hand of the driver. In other words, the potential difference between the potential of first seat electrode 21 that detects one hand of the driver and the potential of first cover electrode 11 that detects the thigh of driver is greater than the potential difference between the potential of first seat electrode 21 when configured to detect the right hand of the driver and the potential of second seat electrode 22 when configured to detect the left hand of the driver. Consequently, with measurement device 2 according to the present embodiment, an ECG waveform can be measured more accurately.

Moreover, with measurement device 2 according to the present embodiment, in the predetermined period in which the amplitude of the ECG waveform is less than the predetermined value, first selector 90a selects first high pass filter 31. In the period other than the predetermined period, first selector 90a selects first low pass filter 41. Accordingly, with measurement device 2, since the grip detection and the ECG waveform detection can be performed as a result of the predetermined period and the period other than the predetermined period repeating in a cycle, like the ECG waveform does, it is possible to ensure that the grip detection and the ECG waveform detection are performed.

Moreover, in measurement device 2 according to the present embodiment, second cover electrode 12 is provided in a different location on steering wheel 200 than first cover electrode 11. This makes it possible to determine whether both hands are gripping steering wheel 200 or not. For example, by determining whether the driver is appropriately gripping steering wheel 200 with both hands when control of the vehicle is handed over to the driver from a semiautonomous or autonomous driving state, the driver can be, for example, alerted to grip steering wheel 200 with both hands in order to improve the safety of the driver driving the vehicle.

Moreover, since measurement device 2 includes first seat electrode 21 as well, the potential difference between first cover electrode 11 or second cover electrode 12 that detects one hand and first seat electrode 21 that detects the thigh can be measured. Accordingly, with measurement device 2, an ECG waveform can be measured more accurately. In other words, measurement device 2 can improve the accuracy of grip detection and ECG waveform detection performed using both hands.

Moreover, with measurement device 2 according to the present embodiment, control circuit 61 switches multiplexer 60 so as to cause electrocardiographic detection circuit 70 to output a signal indicating detection results according to two of the four detection signals obtained from first cover electrode 11, second cover electrode 12, first seat electrode 21, and second seat electrode 22. Accordingly, control circuit 61 can cause multiplexer 60 to extract two of the four detection signals from first cover electrode 11, second cover electrode 12, first seat electrode 21, and second seat electrode 22 by switching multiplexer 60. Stated differently, since control circuit 61 can arbitrarily select two of the four electrodes, measurement device 2 can perform grip detection and ECG waveform detection suited to the driver's posture, for example.

Moreover, with measurement device 2 according to the present embodiment, when first low pass filter 41 and second low pass filter 42 are selected, by extracting, from among the four detection signals from the four electrodes—first cover electrode 11, second cover electrode 12, first seat electrode, 21, and second seat electrode 22—an optimal combination of two detection signals, that is, the combination that has the greatest output width, control circuit 61 can select the combination of the two electrodes that correspond to the two extracted detection signals. In other words, control circuit 61 can select the combination of the two electrodes that have the greatest potential difference. Accordingly, with measurement device 2, the accuracy of the ECG waveform detection can be increased with more certainty.

Moreover, with measurement device 2 according to the present embodiment, on the wiring path from first cover electrode 11 to electrocardiographic detection circuit 70, first low pass filter 41 and first voltage follower circuit 50a are disposed closer to first cover electrode 11 than electrocardiographic detection circuit 70. First voltage follower circuit 50a on the wiring path from first cover electrode 11 to electrocardiographic detection circuit 70 can convert the output impedance of the wiring path to electrocardiographic detection circuit 70 to a low impedance. Accordingly, with measurement device 2, it is possible to inhibit the influence of noise on the wiring path between first voltage follower circuit 50a and electrocardiographic detection circuit 70.

Moreover, with measurement device 2 according to the present embodiment, on the wiring path from first seat electrode 11 to electrocardiographic detection circuit 70, first low pass filter 41 and first voltage follower circuit 50a are disposed closer to first seat electrode 11 than electrocardiographic detection circuit 70. Moreover, on the wiring path from second seat electrode 12 to electrocardiographic detection circuit 70, second low pass filter 42 and second voltage follower circuit 50b are disposed closer to second seat electrode 12 than electrocardiographic detection circuit 70. First voltage follower circuit 50a on the wiring path from first seat electrode 11 to electrocardiographic detection circuit 70 and second voltage follower circuit 50b on the wiring path from second seat electrode 12 to electrocardiographic detection circuit 70 can convert the output impedance of the wiring path to electrocardiographic detection circuit 70 to a low impedance. Accordingly, with this measurement device, it is possible to inhibit the influence of noise on the wiring paths between first and second voltage follower circuits 50a and 50b and electrocardiographic detection circuit 70.

### Variation of Embodiment 4

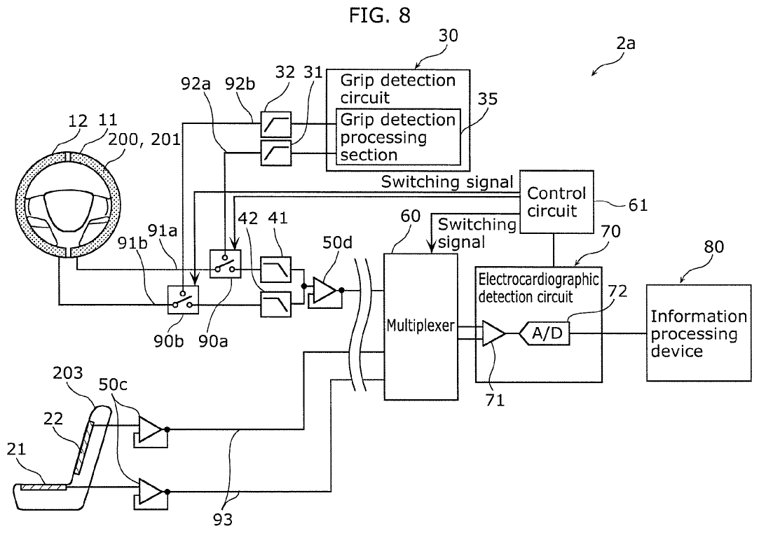

FIG. 8 is a block diagram of measurement device 2a according to a variation of Embodiment 4.

Unless otherwise stated, the configuration of measurement device 2a according to the present variation is the same as that of Embodiment 4 and the like. Moreover, same configurations share like reference signs, and repeated description thereof in detail will be omitted.

In FIG. 6 of Embodiment 4, first voltage follower circuit 50a and second voltage follower circuit 50b are exemplified as being provided on the output sides of first low pass filter 41 and second low pass filter 42, respectively, but as illustrated in FIG. 8, in the present variation , the output side of first low pass filter 41 and the output side of second low pass filter 42 are electrically connected.

As illustrated in FIG. 8, in the present variation , the output of first low pass filter 41 and the output of second low pass filter 42 are combined (electrically connected together), and input into electrocardiographic detection circuit 70. More specifically, the detection signal output by first cover electrode 11 and the detection signal output by second cover electrode 12 are unified via first low pass filter 41 and second low pass filter 42 and input into a single fourth voltage follower circuit 50d. In other words, since the detection signals output from first low pass filter 41 and second low pass filter 42 become a single signal, first cover electrode 11 and second cover electrode 12 behave as a single electrode. Fourth voltage follower circuit 50d is one example of the first voltage follower circuit and the second voltage follower circuit.

In this way, with measurement device 2a according to the present variation , the detection signal from first cover electrode 11 and the detection signal from second cover electrode 12 are combined and input into electrocardiographic detection circuit 70. Accordingly, first cover electrode 11 and second cover electrode 12 behave as a single electrode. This increases the surface area of the electrodes that oppose the hands of the driver, which increases the accuracy of the ECG waveform detection with more certainty.

Moreover, the present variation performs and achieves the same function and advantages as Embodiment 4 and the like.

### Embodiment 5

### Measurement Device 2b Configuration

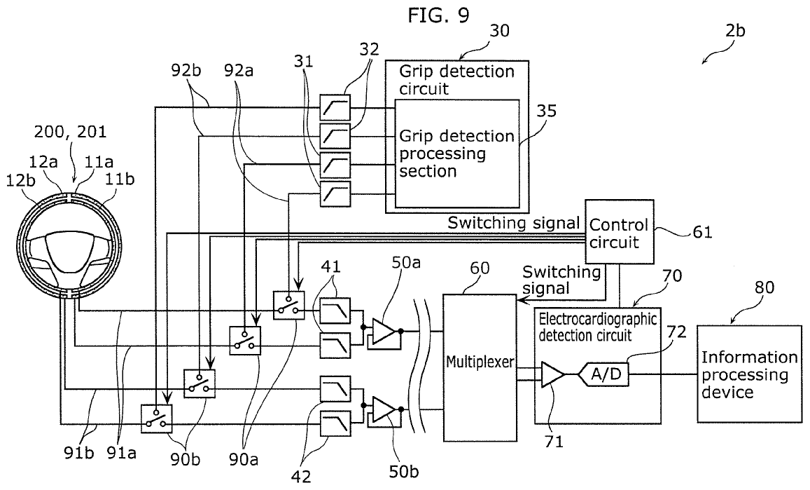

FIG. 9 is a block diagram of measurement device 2b according to Embodiment 5.

In FIG. 6 of Embodiment 4, steering wheel cover 110 in FIG. 2 includes first cover electrode 11 and second cover electrode 12, but as is illustrated in FIG. 9, with measurement device 2b according to the present embodiment, the first cover electrode is split into two first cover electrodes 11a and 11b, and the second cover electrode is split into two second cover electrodes 12a and 12b so that measurement device 1b includes four cover electrodes. Accordingly, in the present embodiment, a pair of first high pass filters 31 and a pair of first low pass filters 41 are electrically connected to the output sides of the pair of first cover electrodes 11a ad 11b, and a pair of second high pass filters 32 and a pair of second low pass filters 42 are electrically connected to the output sides of the pair of second cover electrodes 12a and 12b.

Moreover, although first seat electrode 21 and second seat electrode 22 are not provided in measurement device 2b according to the present embodiment, first seat electrode 21 and second seat electrode 22 that are electrically connected to electrocardiographic detection circuit 70 like in FIG. 6 of Embodiment 4 may be provided in measurement device 1b according to the present embodiment. In the present embodiment, the pair of first cover electrodes 11a and lib is one example of the first electrode, and the pair of second cover electrodes 12a and 12b is one example of the second electrode.

Unless otherwise stated, the configuration of measurement device 2b according to the present embodiment is the same as that of Embodiment 4. Moreover, same configurations share like reference signs, and repeated description thereof in detail will be omitted.

### Function and Advantages

Next, the function and advantages of measurement device 2b according to the present embodiment will be described.

As described above, with measurement device 2b according to the present embodiment, in a state in which the driver is sitting in the driver's seat and gripping steering wheel 200, as a result of second selector 90b selecting second low pass filters 42 and second high pass filters 32, the detection signals from the pair of second cover electrodes 12a and 12b are input into grip detection circuit 30 via second high pass filters 32, and the detection signals from the pair of second cover electrodes 12a and 12b are input into electrocardiographic detection circuit 70 via second low pass filters 42. Moreover, as a result of first selector 90a selecting first low pass filters 41 and first high pass filters 31 in synchronization with second selector 90b, the detection signals from the pair of first cover electrodes 11a and 11b are input into grip detection circuit 30 via first high pass filters 32, and the detection signals from the pair of first cover electrodes 11a and 11b are input into electrocardiographic detection circuit 70 via first low pass filters 41. Accordingly, the presence of dead regions in the grip detection and ECG waveform detection, and a reduction in electrode sensitivity, like is seen with conventional techniques, are less likely to occur.

Since providing a pair of first cover electrodes 11a and 11b and a pair of second cover electrodes 12a and 12b on steering wheel 200 allows for both grip detection and ECG waveform detection to be performed, the installment of measurement device 2b is simplified.

Moreover, with measurement device 2b according to the present embodiment, since grip detection circuit 30 outputs, independently of each other, signals indicating detection results according to the detection signals from the pair of first cover electrodes 11a and 11b and signals indicating detection results according to the detection signals from the pair of second cover electrodes 12a and 12b, it is possible to detect whether steering wheel 200 is being gripped by both hands or not, as described above. Accordingly, with measurement device 2b, the safety of the driver driving the vehicle can be further increased.

Moreover, with measurement device 2b according to the present embodiment, on the wiring path from the pair of first cover electrodes 11a and lib to electrocardiographic detection circuit 70, first low pass filters 41 and first voltage follower circuit 50a are disposed closer to the pair of first cover electrodes 11a and 11b than electrocardiographic detection circuit 70. Moreover, on the wiring path from the pair of second cover electrodes 12a and 12b to electrocardiographic detection circuit 70, second low pass filters 42 and second voltage follower circuit 50b are disposed closer to the pair of second cover electrodes 12a and 12b than electrocardiographic detection circuit 70. First voltage follower circuit 50a on the wiring path from the pair of first cover electrodes 11a and 11b to electrocardiographic detection circuit 70 and second voltage follower circuit 50b on the wiring path from the pair of second cover electrodes 12a and 12b to electrocardiographic detection circuit 70 can convert the output impedance of the wiring path to electrocardiographic detection circuit 70 to a low impedance. Accordingly, with this measurement device, it is possible to inhibit the influence of noise on the wiring paths between first and second voltage follower circuits 50a and 50b and electrocardiographic detection circuit 70.

Moreover, the present embodiment performs and achieves the same function and advantages as Embodiment 4 and the like.

### Embodiment 6

### Measurement Device 2c Configuration

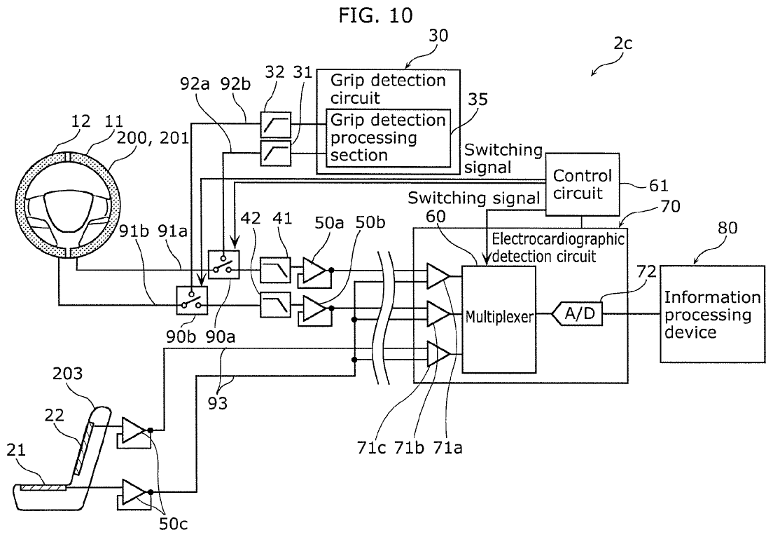

FIG. 10 is a block diagram of measurement device 2c according to Embodiment 6.

In FIG. 6 of Embodiment 4, multiplexer 60 is provided between amplification circuit 71 and the voltage follower circuits, but as is illustrated in FIG. 10, in the present embodiment, multiplexer 60 is provided between a plurality of amplification circuits and A/D converter 72.

Unless otherwise stated, the configuration of measurement device 2c according to the present embodiment is the same as that of Embodiment 4 and the like. Moreover, same configurations share like reference signs, and repeated description thereof in detail will be omitted.

Each of the amplification circuits in electrocardiographic detection circuit 70 is electrically connected to two of the plurality of voltage follower circuits. More specifically, all amplification circuits are electrically connected to third voltage follower circuit 50c that corresponds to first seat electrode 21. Moreover, third voltage follower circuits 50c, first voltage follower circuit 50a, and second voltage follower circuit 50b that respectively correspond to second seat electrode 22, first cover electrode 11, and second cover electrode 12 are electrically connected to a plurality of amplification circuits in one to one correspondence. In the present embodiment, first seat electrode 21 is set as a reference potential electrode. More specifically, the input side of first amplification circuit 71a is electrically connected to first low pass filter 41 via first voltage follower circuit 50a and to first seat electrode 21 via the corresponding third voltage follower circuits 50c, and the output side of first amplification circuit 71a is electrically connected to multiplexer 60. The input side of second amplification circuit 71b is electrically connected to second low pass filter 42 via second voltage follower circuit 50b and to first seat electrode 21 via the corresponding third voltage follower circuits 50c, and the output side of second amplification circuit 71b is electrically connected to multiplexer 60. The input side of third amplification circuit 71c is electrically connected to first seat electrode 21 and second seat electrode 22 via the corresponding third voltage follower circuits 50c, and the output side of third amplification circuit 71c is electrically connected to multiplexer 60.

### Function and Advantages

Next, the function and advantages of measurement device 2c according to the present embodiment will be described.

As described above, in measurement device 2c according to the present embodiment, control circuit 61 switches multiplexer 60 so that (i) any one of first cover electrode 11, second cover electrode 12, and second seat electrode 22, (ii) first seat electrode 21, and (iii) electrocardiographic detection circuit 70 are electrically connected. Accordingly, as a result of control circuit 61 switching multiplexer 60, it is possible to select a given potential difference from among three potential differences—namely the potential difference between the potential of first cover electrode 11 and the potential of first seat electrode 21, the potential difference between the potential of second cover electrode 12 and the potential of first seat electrode 21, and the potential difference between the potential of second seat electrode 22 and the potential of first seat electrode 21. In other words, control circuit 61 causes multiplexer 60 to extract one differential amplification signal from among the differential amplification signals output from first amplification circuit 71a, second amplification circuit 71b, and third amplification circuit 71c. As a result, control circuit 61 can select an appropriate differential amplification signal from among a plurality of differential amplification signals, whereby measurement device 2c can further improve the accuracy of the grip detection and the ECG waveform detection.

Moreover, the present embodiment performs and achieves the same function and advantages as Embodiment 4 and the like.

### Embodiment 7

### Measurement Device 2e Configuration

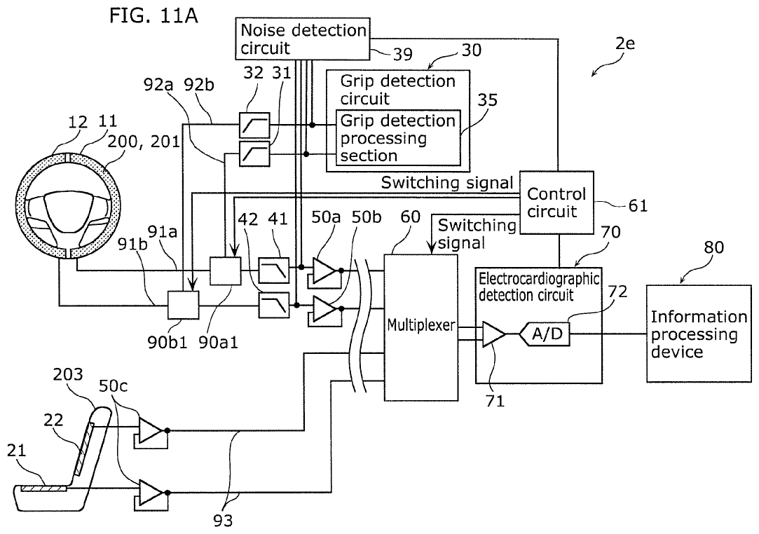

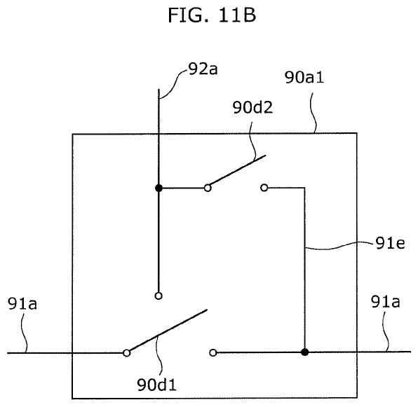

FIG. 11A is a block diagram of measurement device 2e according to Embodiment 7.

The configuration illustrated in FIG. 11A of the present embodiment differs from the configurations of Embodiment 1 and the like in that the selectors may select both high and low pass filters.

Unless otherwise stated, the configuration of measurement device 2e according to the present embodiment is the same as that of Embodiment 1 and the like. Moreover, same configurations share like reference signs, and repeated description thereof in detail will be omitted.

Measurement device 2e includes first selector 90a1, second selector 90b1, and noise detection circuit 39 in addition to first cover electrode 11, second cover electrode 12, first seat electrode 21, second seat electrode 22, first high pass filter 31, second high pass filter 32, grip detection circuit 30, first low pass filter 41, second low pass filter 42, first voltage follower circuit 50a, second voltage follower circuit 50b, third voltage follower circuits 50c, multiplexer 60, control circuit 61, electrocardiographic detection circuit 70, and information processing device 80.

First selector 90a1 is capable of selecting both first low pass filter 41 and first high pass filter 31. In other words, first selector 90a1 includes functionality for, upon obtaining a detection signal output from first cover electrode 11 that indicates contact with steering wheel cover 110 illustrated in FIG. 2, outputting the obtained detection signal to both first low pass filter 41 and first high pass filter 31. Accordingly, first selector 90a1 includes a plurality of switches that enable the selection of at least one of first low pass filter 41 and first high pass filter 31.

Next, the configuration of first selector 90a1 will be described with reference to FIG. 11B. FIG. 11B schematically illustrates first selector 90a1 and the plurality of switches 90d1 and 90d2 included in measurement device 2e according to Embodiment 7.

First selector 90a1 includes a plurality of switches 90d1 and 90d2 and wiring 91e. Switch 90d1 is provided so as to be electrically connected with wiring 91a that extends from first cover electrode 11, and selects one of an electrical connection with wiring 92a that extends from first high pass filter 31 and an electrical connection with wiring 91a that extends from first low pass filter 41. Switch 90d2 is provided so as to be electrically connected with wiring 91e, and electrically connects (ON) or disconnects (OFF) wiring 92a that extends from first high pass filter 31 and wiring 91a that extends from first low pass filter 41. When first selector 90a1 is to select both first low pass filter 41 and first high pass filter 31, switches 90d1 and 90d2 obtain switching signals output from control circuit 61. Consequently, switch 90d1 electrically connects with either wiring 92a that extends from first high pass filter 31 or wiring 91a that extends from first low pass filter 41, and switch 90d2 electrically connects wiring 92a that extends from first high pass filter 31 with wiring 91a that extends from first low pass filter 41. Consequently, the detection signal from first cover electrode 11 reaches both first high pass filter 31 and first low pass filter 41. Moreover, if the noise level of the detection signal is greater than or equal to a predetermined noise level, control circuit 61 turns switch 90d2 OFF and electrically connects switch 90d1 to either wiring 92a that extends from first high pass filter 31 or wiring 91a that extends from first low pass filter 41. This will be described in greater detail later.

Second selector 90b1 has the same configuration as first selector 90a1. Accordingly, repeated description thereof will be omitted. The configuration of first selector 90a1 and second selector 90b1 given here is merely one example; the configuration of first selector 90a1 and second selector 90b1 is not limited to the example illustrated in FIG. 11B.

Second selector 90b1 is capable of selecting both second low pass filter 42 and second high pass filter 32 in synchronization with first selector 90a1. In other words, second selector 90b1 includes functionality for, upon obtaining a detection signal output from second cover electrode 12 that indicates contact with steering wheel cover 110 illustrated in FIG. 2, outputting the obtained detection signal to both second low pass filter 42 and second high pass filter 32. Accordingly, second selector 90b1 includes a plurality of switches that enable the selection of at least one of second low pass filter 42 and second high pass filter 32.

Noise detection circuit 39 detects the noise level of detection signals input into electrocardiographic detection circuit 70 and the noise level of detection signals input into grip detection circuit 30. Here, “noise level” refers to an output value of a signal that exceeds an allowable limit in both grip detection and electrocardiographic detection. In a state in which first selector 90a1 has selected both first low pass filter 41 and first high pass filter 31 and second selector 90b1 has selected both second low pass filter 42 and second high pass filter 32, noise detection circuit 39 determines whether at least one of the detection signal that is input into electrocardiographic detection circuit 70 and the detection signal that is input into grip detection circuit 30 has a noise level that is greater than or equal to the predetermined noise level or not.

Noise detection circuit 39 is electrically connected to control circuit 61, and electrically connected to first selector 90a1 and second selector 90b1 via first high pass filter 31 and second high pass filter 32, respectively. In other words, noise detection circuit 39 is electrically connected to wiring 92a that extends between first high pass filter 31 and grip detection circuit 30 and wiring 92b that extends between second high pass filter 32 and grip detection circuit 30. Similarly, noise detection circuit 39 is also electrically connected to the wiring that extends between first low pass filter 41 and first voltage follower circuit 50a, and also electrically connected to the wiring that extends between second low pass filter 42 and second voltage follower circuit 50b. Note that noise detection circuit 39 may be electrically connected to wiring 93.

If at least one of the detection signal that is input into electrocardiographic detection circuit 70 and the detection signal that is input into grip detection circuit 30 has a noise level that is greater than or equal to the predetermined noise level, noise detection circuit 39 outputs a switching signal in accordance with the determination result to first selector 90a1 and second selector 90b1 via control circuit 61. The determination result is either that the amplitude of the ECG waveform detected by electrocardiographic detection circuit 70 is less than a predetermined value or not. With this, if the amplitude of the ECG waveform is less than the predetermined value, first selector 90a1 selects first high pass filter 31 and second selector 90b1 selects second high pass filter 32.

In other words, if the detection signal has a noise level that is greater than or equal to the predetermined noise level, at least one of grip detection and electrocardiographic detection cannot be performed with sufficient accuracy. Accordingly, the amplitude of the ECG waveform detected by electrocardiographic detection circuit 70 being less than the predetermined value means that the heart is between two pulses, i.e., is not pulsing at that point in time, so in order to detect the grip, first selector 90a1 selects first high pass filter 31 at least only in the predetermined period in which the heart is not pulsing, and second selector 90b1 selects second high pass filter 32 at least only in the above-described predetermined period. Then, electrocardiographic detection is performed by causing first selector 90a1 to select first low pass filter 41 and causing second selector 90b1 to select second low pass filter 42 after elapse of the predetermined period.

### Processing

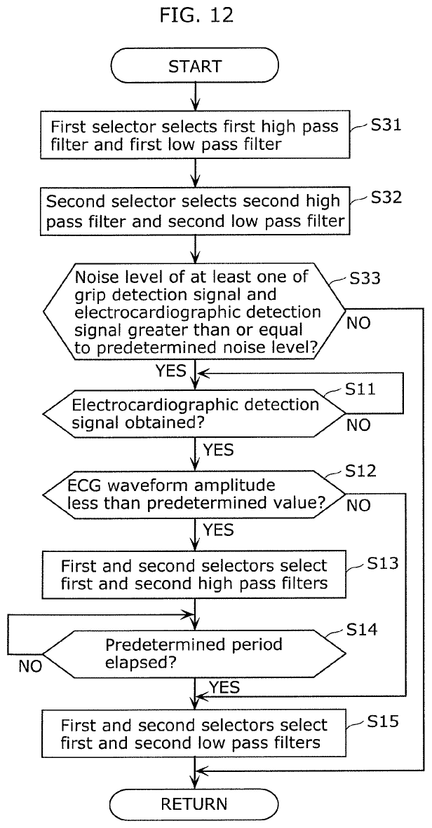

FIG. 12 is a flow chart of processes performed by measurement device 2e according to Embodiment 7. Note that in FIG. 12, the control processing performed by first selector 90a1 and second selector 90b1 in particular will be described. Moreover, the detections by grip detection circuit 30 and electrocardiographic detection circuit 70 are performed after the selection control by first selector 90a1 and second selector 90b1 (i.e., after NO in S33 (to be described later) and after S13 and S15 in FIG. 12).

Unless otherwise stated, the processes performed by measurement device 2e according to the present embodiment are the same as those illustrated in FIG. 7. Moreover, same processes share like reference signs, and repeated description thereof in detail will be omitted.

First, upon obtaining a detection signal output from first cover electrode 11 that indicates contact with steering wheel cover 110 illustrated in FIG. 2, first selector 90a1 outputs the obtained detection signal to both first low pass filter 41 and first high pass filter 31. In other words, first selector 90a1 selects both first low pass filter 41 and first high pass filter 31 (S31).

Next, upon obtaining a detection signal output from second cover electrode 12 that indicates contact with steering wheel cover 110 illustrated in FIG. 2, second selector 90b1 outputs the obtained detection signal to both first second low pass filter 42 and second high pass filter 32. In other words, second selector 90b1 selects both second low pass filter 42 and second high pass filter 32 in synchronization with first selector 90a1 (S32).

Next, noise detection circuit 39 detects the noise level between first high pass filter 31 and grip detection circuit 30 and the noise level between second high pass filter 32 and grip detection circuit 30. Noise detection circuit 39 also detects the noise level between first low pass filter 41 and multiplexer 60 and the noise level between second low pass filter 42 and multiplexer 60. Note that noise detection circuit 39 may detect the noise level between first high pass filter 31 or first low pass filter 41 and first cover electrode 11, and the noise level between second high pass filter 32 or second low pass filter 42 and second cover electrode 12.

Noise detection circuit 39 determines whether a detection signal whose noise level is greater than or equal to the predetermined noise level is present among the detected detection signals (S33).

When noise detection circuit 39 determines that a detection signal whose noise level is greater than or equal to the predetermined noise level is present among the detection signals (YES in S33), the processing proceeds to step S11. Next, the same processes as illustrated in FIG. 7 are performed.

When noise detection circuit 39 determines that a detection signal whose noise level is greater than or equal to the predetermined noise level is not present among the detection signals (NO in S33), the processing illustrated in FIG. 12 ends.

### Function and Advantages

Next, the function and advantages of measurement device 2e according to the present embodiment will be described.

As described above, with measurement device 2e according to the present embodiment, first selector 90a1 is capable of selecting both first low pass filter 41 and first high pass filter 31. This makes it possible to perform electrocardiographic detection and grip detection concurrently. This in turn makes it possible to improve the sensitivity of the electrodes since the dead regions of the electrocardiographic detection and the grip detection are reduced. Moreover, by using the electrocardiographic detection and the grip detection to determine whether the driver is gripping steering wheel 200 or not and determine whether the driver is sitting in the driver's seat or not, the driver can be prompted to grip steering wheel 200, alerted to sit with correct posture in the driver's seat, etc., to improve the safety of the driver that drives the vehicle.

Moreover, the same functions and advantages as described above are performed and achieved when second selector 90b1 selects both second low pass filter 42 and second high pass filter 32 in synchronization with first selector 90a1 as well.

Moreover, with measurement device 2e according to the present embodiment, if the noise level of the detection signal that is input into electrocardiographic detection circuit 70 or the noise level of the detection signal that is input into grip detection circuit 30 is greater than or equal to the predetermined noise level, when both the ECG waveform and the gripping are detected concurrently, accuracy cannot be ensured, so one of the ECG waveform and the gripping is selectively detected. Thus, when the amplitude of the ECG waveform detected by electrocardiographic detection circuit 70 is less than the predetermined value, this means that the heart is between two pulses, i.e., is not pulsing at that point in time, so in the predetermined period in which the heart is not pulsing, first selector 90a is caused to select first high pass filter 31 and second selector 90b is caused to select second high pass filter 32, whereby the grip detection is performed. Then, electrocardiographic detection is performed by causing first selector 90a1 to select first low pass filter 41 and causing second selector 90b1 to select second low pass filter 42 after elapse of the predetermined period. By repeating these operations, if the noise level is low, both the ECG waveform and the gripping are detected concurrently to save time, and if the noise level is high, the ECG waveform and the gripping are selectively detected by time division based on the predetermined period to inhibit the mutual influence of noise on ECG waveform and gripping detection.

Moreover, the present embodiment performs and achieves the same function and advantages as Embodiment 4 and the like.

### Embodiment 8

### Measurement Device 3 Configuration

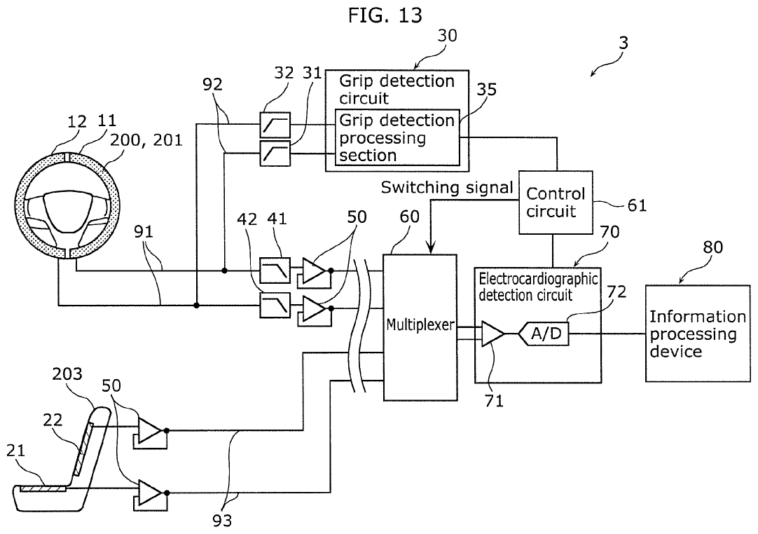

FIG. 13 is a block diagram of measurement device 3 according to Embodiment 8.

FIG. 13 of Embodiment 8 differs from Embodiment 1 and the like in that control circuit 61 outputs a normal grip signal, an anomaly signal, and an insufficient grip signal.

Unless otherwise stated, the configuration of measurement device 3 according to the present embodiment is the same as that of Embodiment 1 and the like. Moreover, same configurations share like reference signs, and repeated description thereof in detail will be omitted.

### Grip Detection Circuit 30

Grip detection processing section 35 included in grip detection circuit 30 is electrically connected to control circuit 61. Grip detection processing section 35 outputs, to control circuit 61 and information processing device 80 and the like, independently of each other, a grip detection signal indicating a detection result according to the detection signal resulting from the detection by first cover electrode 11, and a grip detection signal indicating a detection result according to the detection signal resulting from the detection by second cover electrode 12. More specifically, the grip detection signal is a signal indicating a detection result from first cover electrode 11 indicating that the driver's hand is contacting steering wheel cover 110 and a signal indicating a detection result from second cover electrode 12 indicating that the driver's hand is contacting steering wheel cover 110.

A/D converter 72 included in electrocardiographic detection circuit 70 is electrically connected to the output side of amplification circuit 71, and electrically connected to the input side of information processing device 80. A/D converter 72 converts the input differential amplification signal from analog to digital, and inputs the digital differential amplification signal into control circuit 61 and information processing device 80 and the like. The differential amplification signal that is input into control circuit 61 is an electrocardiographic detection signal indicating the detection result of the ECG waveform detection performed on the driver. When electrocardiographic detection circuit 70 does not detect the ECG waveform of the driver, electrocardiographic detection circuit 70 does not output the differential amplification signal.

### Control Circuit 61

Control circuit 61 is provided internally in driver's seat 203, for example. Control circuit 61 is electrically connected to grip detection circuit 30 and electrocardiographic detection circuit 70. Control circuit 61 obtains, from grip detection circuit 30, grip detection signals indicating that the driver's hand is gripping steering wheel 200. More specifically, control circuit 61 obtains, from grip detection circuit 30, independently of each other, a grip detection signal indicating a detection result according to the detection signal resulting from the detection by first cover electrode 11 and a grip detection signal indicating a detection result according to the detection signal resulting from the detection by second cover electrode 12.

Moreover, control circuit 61 obtains electrocardiographic detection signals indicating the ECG waveform of the driver from electrocardiographic detection circuit 70. More specifically, control circuit 61 obtains, from electrocardiographic detection circuit 70, independently from each other, electrocardiographic detection signals expressed as the two of the four detection signals from the four electrodes—first cover electrode 11, second cover electrode 12, first seat electrode, 21, and second seat electrode 22—that are an optimal combination that has the greatest output width.

Upon obtaining the grip detection signals from grip detection circuit 30 and the electrocardiographic detection signals from electrocardiographic detection circuit 70, control circuit 61 outputs a normal grip signal. In other words, control circuit 61 obtaining the grip detection signals and the electrocardiographic detection signals indicates that the driver is sitting in the driver's seat and gripping the steering wheel 200. In the present embodiment, control circuit 61 outputs a normal grip signal upon obtainment of two grip detection signals and two electrocardiographic detection signals, but the number of grip detection signals and electrocardiographic detection signals that are obtained may vary depending on the number of electrodes. Moreover, the number of grip detection signals obtained may differ from the number of electrocardiographic detection signals obtained.

Control circuit 61 outputs an insufficient grip signal when a grip is detected via only one of first cover electrode 11 and second cover electrode 12. In other words, when only the grip detection signal from first cover electrode 11, which is the detection signal of the detection result by first cover electrode 11, or only the grip detection signal from second cover electrode 12, which is the detection signal of the detection result by second cover electrode 12 is obtained by control circuit 61, this indicates that the driver is not gripping steering wheel 200 with both hands. Accordingly, control circuit 61 inputs an insufficient grip signal that indicates that both hands are not gripping steering wheel 200 into information processing device 80.

Note that control circuit 61 may output the insufficient grip signal when only one of first seat electrode 21 and second seat electrode 22 outputs the detection signal resulting from a detection. In other words, when at least one of the detection signal resulting from the detection by first seat electrode 21 and the detection signal resulting from the detection by second seat electrode 22 is not obtained by control circuit 61, this indicates that the driver is not sitting in the driver's seat with correct posture. Accordingly, control circuit 61 may output the insufficient grip signal that indicates that the driver is not sitting in the driver's seat with correct posture to information processing device 80.

Moreover, control circuit 61 outputs an anomaly signal when grip detection circuit 30 detects a grip and electrocardiographic detection circuit 70 does not detect an ECG waveform. For example, in such cases, there may be a possibility that a person from a passenger seat is gripping steering wheel 200, or that a conductive material has been wrapped around steering wheel 200. In other words, the anomaly signal is a signal output by control circuit 61 when it can be estimated that the driver is being spoofed, as if the driver were sitting in the driver's seat and gripping steering wheel 200. Accordingly, control circuit 61 inputs an anomaly signal that indicates that the driver is not sitting in the driver's seat and is not gripping steering wheel 200 into information processing device 80.

Moreover, if the amplitude of the ECG waveform detected by electrocardiographic detection circuit 70 is less than a predetermined value, control circuit 61 outputs the insufficient grip signal. In other words, when the potential difference of two of the four detection signals output by first cover electrode 11, second cover electrode 12, first seat electrode 21, and second seat electrode 22 is small, this indicates that the driver is not sitting with correct posture in the driver's seat. Accordingly, control circuit 61 outputs the insufficient grip signal that indicates that the driver is not sitting in the driver's seat with correct posture, that is to say, indicating that the driver's posture is poor, to information processing device 80.

Note that the amplitude of the ECG waveform is the heartbeat based on the ECG waveform, that is to say, the pulse of the heart, and is, for example, the amplitude of the R wave, Q wave, S wave, etc. In the present embodiment, the amplitude of the ECG waveform is the amplitude of the R wave.

Moreover, control circuit 61 sequentially switches multiplexer 60 so as to sequentially select all possible combinations of electrical connections between (i) any two of first cover electrode 11, second cover electrode 12, first seat electrode 21, and second seat electrode 22 and (ii) electrocardiographic detection circuit 70. Stated differently, control circuit 61 controls multiplexer 60 so as to cause multiplexer 60 to output, from among all possible combinations of the four detection signals, detection signals whose output width (amplitude) is a maximum of two detection signals (a combination of a maximum of two detection signals).

More specifically, control circuit 61 selects all possible combinations of any two of the four detection signals obtained from first cover electrode 11, second cover electrode 12, first seat electrode 21, and second seat electrode 22, and from among the selected combinations, extracts a combination of detection signals from two electrodes whose output width is the greatest.

For example, control circuit 61 performs this extraction based on the detection result by electrocardiographic detection circuit 70. Control circuit 61 references all possible combinations of any two of the four detection signals obtained by multiplexer 60, and extracts a combination exhibiting the greatest potential difference between the two electrodes as indicated by the two detection signals in the combination.

Control circuit 61 outputs a switching signal that controls multiplexer 60 to extract the combination exhibiting the greatest potential difference between the two electrodes.

Note that control circuit 61 may be provided internally in information processing device 80, and, alternatively, may be provided as a separate device, like in the present embodiment.

### Processing

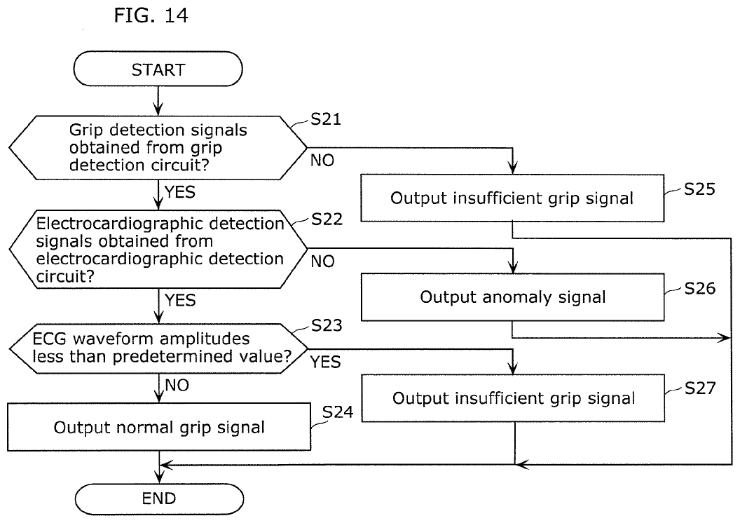

Next, processes performed by control circuit 61 will be described with reference to FIG. 14.

FIG. 14 is a flow chart of processes performed by measurement device 3 according to Embodiment 8.

First, control circuit 61 determines whether the grip detection signal from first cover electrode 11, which is the detection signal of the detection result by first cover electrode 11, and the grip detection signal from second cover electrode 12, which is the detection signal of the detection result by second cover electrode 12, have been obtained. In other words, control circuit 61 determines whether grip detection signals have been obtained from grip detection circuit 30 or not (S21). In other words, in the present embodiment, in order to determine whether the driver is gripping steering wheel 200 with both hands or not, control circuit 61 determines whether it has obtained two grip detection signals or not.

When at least one of these two grip detection signals has not been obtained (NO in S21), this indicates that the driver is gripping steering wheel 200 with only one hand or is not gripping steering wheel 200 at all. Accordingly, control circuit 61 outputs an insufficient grip signal that indicates that both hands are not gripping steering wheel 200 to information processing device 80 (S25). For example, information processing device 80 causes the alerting device to alert the driver to grip the steering wheel with both hands. Control circuit 61 then ends the processing.

When the two grip detection signals have been obtained (YES in S21), control circuit 61 determines whether the detection signal resulting from the detection by first seat electrode 21 and the detection signal resulting from the detection by second seat electrode 22 have been obtained or not (S22). In other words, in order to determine whether the driver is sitting in the driver's seat or not, control circuit 61 determines whether an electrocardiographic detection signals have been obtained from electrocardiographic detection circuit 70 or not. Note that the electrocardiographic detection signal includes information indicating which two of the four detection signals from first cover electrode 11, second cover electrode 12, first seat electrode 21, and second seat electrode 22 have been selected.

When the electrocardiographic detection signals have not been obtained (NO in S22), that is, when it can be estimated that the driver is being spoofed, as if the driver were sitting in the driver's seat and gripping steering wheel 200, control circuit 61 outputs the anomaly signal indicating that the driver is not sitting in the driver's seat and not gripping steering wheel 200, and inputs the anomaly signal into information processing device 80 (S26). Note that control circuit 61 may determine that the driver is sitting in the driver's seat when at least one detection signal is output from among first seat electrode 21 and second seat electrode 22, and may determine that the driver is sitting in the driver's seat when first seat electrode 21 outputs the detection signal.

For example, information processing device 80 causes the alerting device to alert the driver to sit in the driver's seat with correct posture. Control circuit 61 then ends the processing.

When the detection signals are obtained (YES in S22), control circuit 61 determines whether the amplitudes of the ECG waveforms indicated by the electrocardiographic detection signals are less than a predetermined value or not (S23). In other words, even if the electrocardiographic detection signals are obtained, control circuit 60 determines whether the driver's posture is poor or not, such as if the driver is twisting his or her body or significantly arching his or her back.

When the amplitudes of the ECG waveforms indicated by the electrocardiographic detection signals are less than the predetermined value (YES in S23), that is, when the driver's posture is poor, control circuit 61 outputs the insufficient grip signal indicating that the driver's posture is poor, and inputs the insufficient grip signal into information processing device 80 (S27). For example, information processing device 80 causes the alerting device to alert the driver to sit in the driver's seat with correct posture. Control circuit 61 then ends the processing.

When the amplitudes of the ECG waveforms indicated by the electrocardiographic detection signals are greater than or equal to the predetermined value (NO in S23), that is, when the driver is sitting in the driver's seat with correct posture, control circuit 61 outputs the normal grip signal and inputs the normal grip signal into information processing device 80 (S24). Control circuit 61 then ends the processing.

### Function and Advantages

Next, the function and advantages of measurement device 3 according to the present embodiment will be described.

As described above, with measurement device 3 according to the present embodiment, in a state in which the driver is sitting in driver's seat 203 and gripping steering wheel 200, a detection signal resulting from the gripping is input into grip detection circuit 30 from first cover electrode 11 via first high pass filter 31, and a detection signal resulting from the gripping is input into grip detection circuit 30 from second cover electrode 12 via second high pass filter 32. Moreover, in this state, a detection signal indicating an ECG waveform is input into electrocardiographic detection circuit 70 from first cover electrode 11 via first low pass filter 41, and a detection signal indicating an ECG waveform is input into electrocardiographic detection circuit 70 from second cover electrode 12 via second low pass filter 42. Moreover, for example, electrocardiographic detection circuit 70 receives an input of a detection signal from second cover electrode 12 or first seat electrode 21, each of which is one example of the second electrode. Accordingly, grip detection circuit 30 can perform grip detection based on changes in electrostatic capacitance between first cover electrode 11 and the driver's hand, from the detection signal input via first high pass filter 31. Moreover, electrocardiographic detection circuit 70 can detect the ECG waveform of the driver, from the potential difference between the potential of first cover electrode 11 and the potential of second cover electrode 12 or first seat electrode 21. Accordingly, the presence of dead regions in the grip detection and ECG waveform detection, and a reduction in electrode sensitivity, like is seen with conventional techniques, are less likely to occur.

Accordingly, the accuracy of the grip detection and the ECG waveform detection can be inhibited from decreasing. As a result, it can be ensured that control circuit 61 will output a normal grip signal when grip detection circuit 30 detects an ECG waveform and it can be ensured that control circuit 61 will output a normal grip signal when electrocardiographic detection circuit 70 detects an ECG waveform.

In particular, as a result of each of first cover electrode 11 and second cover electrode 12 being used commonly as both an electrode for the ECG waveform detection and an electrode for the grip detection, the same electrode can be used to perform the grip detection and the ECG waveform detection. Accordingly, cases in which loss of detection of a grip on steering wheel 200 occurs in one region and loss of ECG waveform detection occurs in another region, that is to say, cases in which dead regions are present in both regions is unlikely. Consequently, grip detection and ECG waveform detection can be performed with certainty.

Moreover, with measurement device 3, since grip detection and ECG waveform detection need not be performed using respective electrodes, the manufacturing cost of measurement device 3 can be inhibited from steeply increasing and the structure of measurement device 2 can be kept from becoming overly complicated.

Moreover, with measurement device 3, since an electrode for ECG waveform detection and an electrode for grip detection need not be wrapped around rim 201, steering wheel 200 can be inhibited from being difficult to grip due to an increase in the thickness of steering wheel cover 110.

Moreover, with measurement device 3 according to the present embodiment, providing first seat electrode 21 on front surface section 203a allows for the utilization of a part of the body that is characterized by a conductive path through the body—from the hand of the driver to the thigh of the driver—that is longer than the conductive path from the left hand of the driver to the right hand of the driver. In other words, the potential difference between the potential of first seat electrode 21 that detects one hand of the driver and the potential of first cover electrode 11 that detects the thigh of driver is greater than the potential difference between the potential of first seat electrode 21 when configured to detect the right hand of the driver and the potential of second seat electrode 22 when configured to detect the left hand of the driver. Consequently, with measurement device 3 according to the present embodiment, an ECG waveform can be measured more accurately.

Moreover, in measurement device 3 according to the present embodiment, second cover electrode 12 is provided in a different location on steering wheel 200 than first cover electrode 11. This makes it possible to determine whether both hands are gripping steering wheel 200 or not. For example, by determining whether the driver is appropriately gripping steering wheel 200 with both hands when control of the vehicle is handed over to the driver from a semiautonomous or autonomous driving state, the driver can be, for example, alerted to grip steering wheel 200 with both hands in order to improve the safety of the driver driving the vehicle.

Moreover, since measurement device 3 includes first seat electrode 21 as well, the potential difference between first cover electrode 11 or second cover electrode 12 that detects one hand and first seat electrode 21 that detects the thigh can be measured. Accordingly, with measurement device 3, an ECG waveform can be measured more accurately. In other words, measurement device 3 can improve the accuracy of grip detection and ECG waveform detection performed using both hands.

Moreover, with measurement device 3 according to the present embodiment, since grip detection circuit 30 outputs, independently of each other, a grip detection signal indicating a detection result according to the detection signal from first cover electrode 11 and a grip detection signal indicating a detection result according to the detection signal from second cover electrode 12, it is possible to detect whether steering wheel 200 is being gripped by both hands or not, as described above. Accordingly, with measurement device 3, the safety of the driver driving the vehicle can be further increased by, for example, alerting the driver to grip steering wheel 200 with both hands, based on the insufficient grip signal.

Moreover, with measurement device 3 according to the present embodiment, control circuit 61 switches multiplexer 60 so as to cause electrocardiographic detection circuit 70 to output an electrocardiographic detection signal indicating detection results according to two of the four detection signals obtained from first cover electrode 11, second cover electrode 12, first seat electrode 21, and second seat electrode 22. Accordingly, control circuit 61 can cause multiplexer 60 to extract two of the four detection signals from first cover electrode 11, second cover electrode 12, first seat electrode 21, and second seat electrode 22 by switching multiplexer 60. Stated differently, since control circuit 61 can arbitrarily select two of the four electrodes, measurement device 3 can perform grip detection and ECG waveform detection suited to the driver's posture, for example.

Moreover, with measurement device 3 according to the present embodiment, for example, even if a detection signal is input into electrocardiographic detection circuit 70, if the amplitude of the ECG waveform indicated in this detection signal is less than the predetermined value, the driver may not be sufficiently gripping steering wheel 200, or the posture of the driver may be poor, that is to say, the driver may be sitting in the driver's seat with incorrect posture. In the present embodiment, when the amplitude of the ECG waveform indicated in this detection signal is less than the predetermined value, for example, the driver can be alerted to grip steering wheel 200 with both hands or alerted to sit in the driver's seat with correct posture, based on the insufficient grip signal. Accordingly, with measurement device 3, the safety of the driver driving the vehicle can be increased more certainty.

Moreover, with measurement device 3 according to the present embodiment, for example, when electrocardiographic detection circuit 70 does not detect an ECG waveform even through grip detection circuit 30 detects a grip, there may be a possibility that a person from a passenger seat is gripping steering wheel 200, or that a conductive material has been wrapped around steering wheel 200. With the present embodiment, even if grip detection circuit 30 detects a grip, if electrocardiographic detection circuit 70 does not detect an ECG waveform, control circuit 61 can, for example, alert the driver to sit with correct posture in the driver's seat or to grip steering wheel 200, based on the anomaly signal. Accordingly, with measurement device 3, the safety of the driver driving the vehicle can be increased more certainty.

### Variation of Embodiment 8

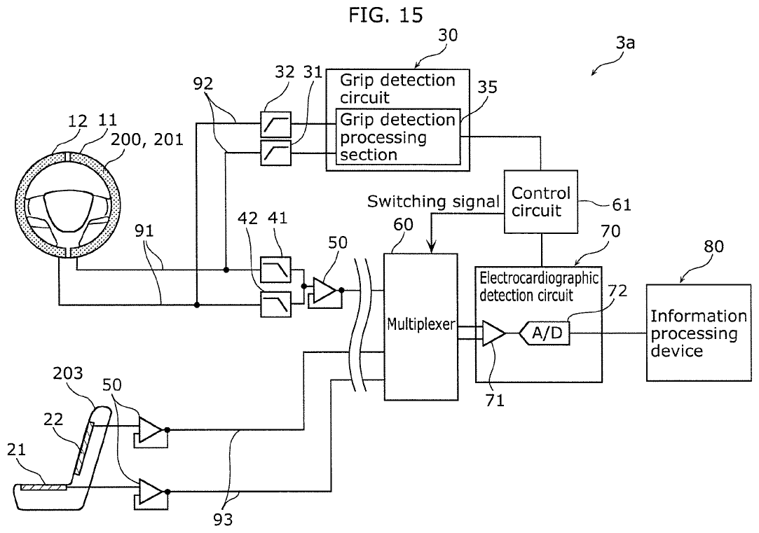

FIG. 15 is a block diagram of measurement device 3a according to a variation of Embodiment 8.

Unless otherwise stated, the configuration of measurement device 3a according to the present variation is the same as that of Embodiment 8. Moreover, same configurations share like reference signs, and repeated description thereof in detail will be omitted.

In FIG. 13 of Embodiment 8, voltage follower circuit 50 is provided on the output sides of each of first low pass filter 41 and second low pass filter 42, but as illustrated in FIG. 15, in the present variation , the output side of first low pass filter 41 and the output side of second low pass filter 42 are electrically connected.

Moreover, the present variation performs and achieves the same function and advantages as Embodiment 8.

### Embodiment 9

### Measurement Device 3b Configuration

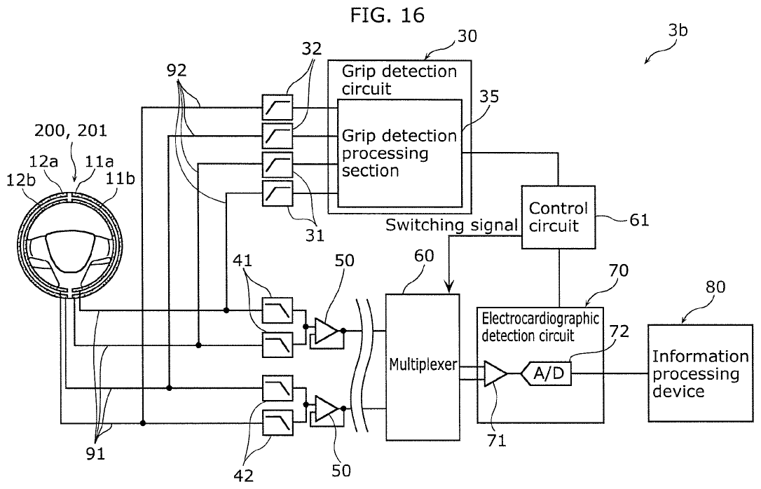

FIG. 16 is a block diagram of measurement device 3b according to Embodiment 9.

In FIG. 13 of Embodiment 8, steering wheel cover 110 in FIG. 2 includes first cover electrode 11 and second cover electrode 12, but as is illustrated in FIG. 16, with measurement device 3b according to the present embodiment, the first cover electrode is split into two first cover electrodes 11a and 11b, and the second cover electrode is split into two second cover electrodes 12a and 12b so that measurement device 1b includes four cover electrodes.

### Processing

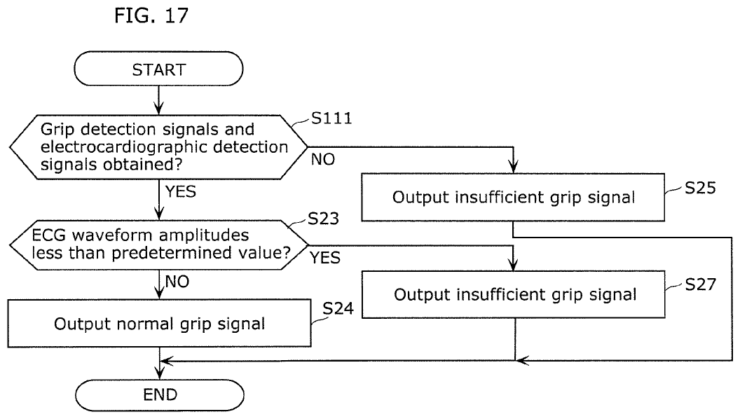

Next, processes performed by control circuit 61 will be described with reference to FIG. 17.

FIG. 17 is a flow chart of processes performed by measurement device 3b according to Embodiment 9.

Processes in FIG. 17 that are the same as FIG. 14 share like reference signs. Accordingly, repeated description thereof will be omitted.

First, control circuit 61 determines whether the grip detection signals from grip detection circuit 30 and the electrocardiographic detection signals from electrocardiographic detection circuit 70 have been obtained (S111). In other words, in order to determine whether the driver is gripping steering wheel 200 with both hands or not, control circuit 61 determines whether it has obtained two grip detection signals or not.

If at least one signal among the set of two grip detection signals and two electrocardiographic detection signals has not been obtained (NO in S111), control circuit 61 proceeds to step S25.

If two grip detection signals and two electrocardiographic detection signals have been obtained (YES in S111), control circuit 61 proceeds to step S23. The subsequent processes are the same as those illustrated in FIG. 14.

Note that in step S111, control circuit 61 may simply determine whether the grip detection signals have been obtained from grip detection circuit 30 or not. In other words, control circuit 61 may determine whether electrocardiographic detection signals have been obtained from electrocardiographic detection circuit 70 or not.

### Function and Advantages

Next, the function and advantages of measurement device 3b according to the present embodiment will be described.

As described above, with measurement device 3b according to the present embodiment, a pair of first cover electrodes 11a and 11b that are electrically connected to first low pass filter 41 are provided on steering wheel 200, and a pair of second cover electrodes 12a and 12b that are electrically connected to second low pass filter 42 are provided on steering wheel 200. Since providing a pair of first cover electrodes 11a and 11b and a pair of second cover electrodes 12a and 12b on steering wheel 200 allows for both grip detection and ECG waveform detection to be performed, the installment of measurement device 3b is simplified.

Moreover, if the grip detection and the ECG waveform detection are performed concurrently, with measurement device 3b, it is possible to estimate that the driver is correctly gripping steering wheel 200 with both hands.

Moreover, with measurement device 3b according to the present embodiment, it is possible to output a normal grip signal when both hands are gripping steering wheel 200 and output an insufficient grip signal when both hands are not gripping steering wheel 200. For example, by determining whether the driver is appropriately gripping steering wheel 200 with both hands, the driver can be, for example, alerted to grip steering wheel 200 with both hands in order to improve the safety of the driver driving the vehicle.

Moreover, the present embodiment performs and achieves the same function and advantages as Embodiment 8.

### Embodiment 10

### Measurement Device 3c Configuration

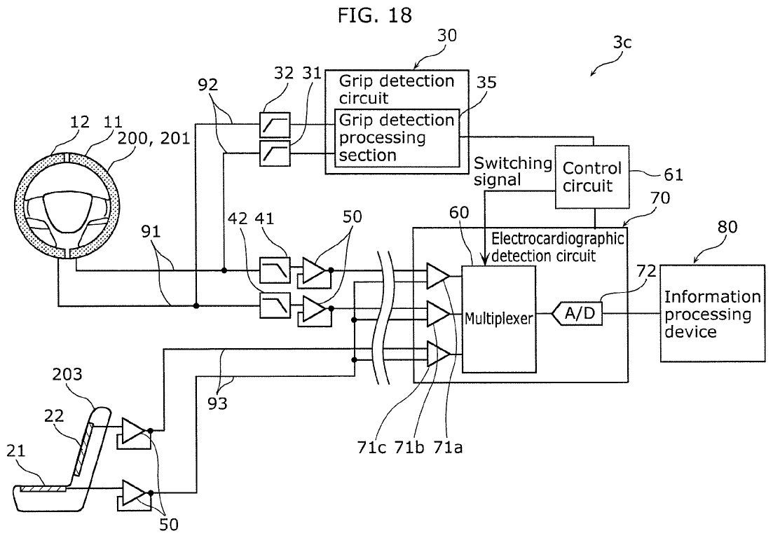

FIG. 18 a block diagram of measurement device 3c according to Embodiment 10.

In FIG. 13 of Embodiment 8, multiplexer 60 is provided between amplification circuit 71 and voltage follower circuits 50, but as is illustrated in FIG. 18, in the present embodiment, multiplexer 60 is provided between a plurality of amplification circuits and A/D converter 72.

Unless otherwise stated, the configuration of measurement device 3c according to the present embodiment is the same as that of Embodiment 8. Moreover, same configurations share like reference signs, and repeated description thereof in detail will be omitted.

### Function and Advantages

Next, the function and advantages of measurement device 3c according to the present embodiment will be described.

As described above, in measurement device 3c according to the present embodiment, control circuit 61 switches multiplexer 60 so that (i) any one of first cover electrode 11, second cover electrode 12, and second seat electrode 22, (ii) first seat electrode 21, and (iii) electrocardiographic detection circuit 70 are electrically connected. Accordingly, as a result of control circuit 61 switching multiplexer 60, it is possible to select a given potential difference from among three potential differences—namely the potential difference between the potential of first cover electrode 11 and the potential of first seat electrode 21, the potential difference between the potential of second cover electrode 12 and the potential of first seat electrode 21, and the potential difference between the potential of second seat electrode 22 and the potential of first seat electrode 21. In other words, control circuit 61 causes multiplexer 60 to extract one differential amplification signal from among the differential amplification signals output from first amplification circuit 71a, second amplification circuit 71b, and third amplification circuit 71c. As a result, control circuit 61 can select an appropriate differential amplification signal from among a plurality of differential amplification signals, whereby measurement device 3c can further improve the accuracy of the grip detection and the ECG waveform detection.

Moreover, the present embodiment performs and achieves the same function and advantages as Embodiment 8 and the like.

### Other Variations, Etc.

Hereinbefore, the present disclosure has been described based on Embodiments 1 through 10 and variations of Embodiments 1, 4, and 8, but the present disclosure is not limited to Embodiments 1 through 10 and the variations of Embodiments 1, 4, and 8.

For example, the measurement device according to any one of Embodiments 1 through 10 and the variations of Embodiments 1, 4, and 8 is exemplified as including four electrodes, but the first cover electrode and the second cover electrode may be provided as a single electrode. Moreover, the first seat electrode and the second seat electrode may be provided as a single electrode. In other words, the measurement device may include three or less electrodes. Moreover, the measurement device may further include one or more electrodes on the steering wheel cover in addition to the first cover electrode and the second cover electrode, and may further include one or more electrodes on the driver's seat in addition to the first seat electrode and the second seat electrode.

Moreover, the measurement device according to any one of Embodiments 1 through 10 and the variations of Embodiments 1, 4, and 8, is exemplified as including a first low pass filter, a second low pass filter, and a first high pass filter and a second high pass filter that correspond to the first cover electrode and the second cover electrode, but the number of first low pass filters and second low pass filters and the number of first high pass filters and second high pass filters may be changed in accordance with the number of electrodes provided. In other words, one low pass filter may be provided, and, alternatively, three or more low pass filters may be provided. Moreover, one high pass filter may be provided, and, alternatively, three or more high pass filters may be provided.

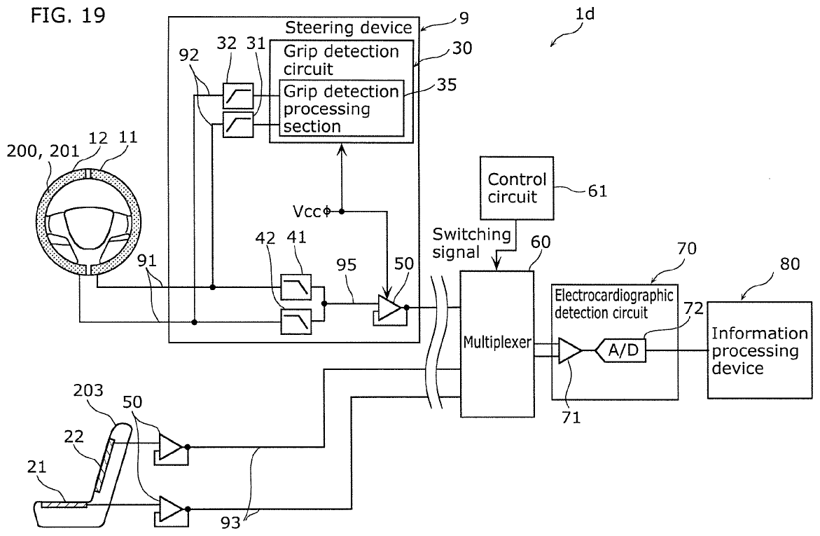

Measurement device 1d according to Embodiments 1 through 3 and the variation of Embodiment 1 is illustrated in FIG. 19. FIG. 19 is a block diagram of measurement device 1d according to a variation. As illustrated in FIG. 19, in measurement device 1d, grip detection circuit 30, first high pass filter 31, second high pass filter 32, first low pass filter 41, second low pass filter 42, and voltage follower circuit 50 are collectively included in a single device, namely steering device 9. With this configuration, voltage follower circuit 50 provided on wiring 91 may be electrically connected to positive supply voltage Vcc. Positive supply voltage Vcc may also be electrically connected to grip detection circuit 30. With this, there is no need to lead wiring for supplying power from electrocardiographic detection circuit 70 to voltage follower circuit 50 or wiring for grounding from voltage follower circuit 50 to electrocardiographic detection circuit 70. Accordingly, the physical size of measurement device 1d can be reduced and manufacturing costs can be inhibited from steeply increasing. Note that steering device 9 described above may further include multiplexer 60. In such cases, multiplexer 60 may be provided on the output side or input side of voltage follower circuit 50 on wiring 95. The detection signals from first seat electrode 21 and second seat electrode 22 may be input into multiplexer 60. Moreover, wiring 95 is wiring that extends from the connection point of the two wirings 91 to multiplexer 60.

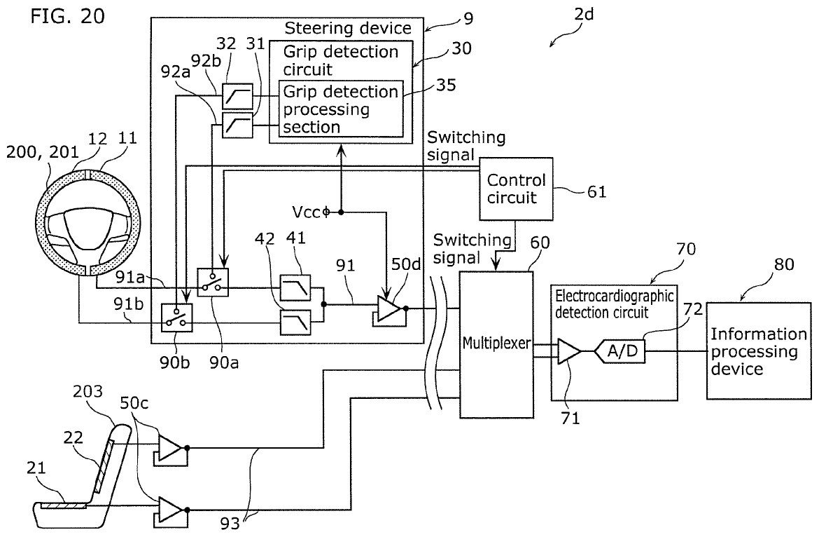

Measurement device 2d according to Embodiments 4 through 6 and the variation of Embodiment 4 is illustrated in FIG. 20. FIG. 20 is a block diagram of measurement device 2d according to a variation. As illustrated in FIG. 20, in measurement device 2d, grip detection circuit 30, first high pass filter 31, second high pass filter 32, first low pass filter 41, second low pass filter 42, and fourth voltage follower circuit 50d are collectively included in a single device, namely steering device 9. Moreover, first selector 90a and second selector 90b may also be collectively included in steering device 9. With this configuration, fourth voltage follower circuit 50d may be electrically connected to positive supply voltage Vcc. Positive supply voltage Vcc may also be electrically connected to grip detection circuit 30. With this, there is no need to lead wiring for supplying power from electrocardiographic detection circuit 70 to fourth voltage follower circuit 50d or wiring for grounding from fourth voltage follower circuit 50d to electrocardiographic detection circuit 70. Accordingly, the physical size of measurement device 2d can be reduced and manufacturing costs can be inhibited from steeply increasing. Note that steering device 9 described above may further include multiplexer 60. In such cases, multiplexer 60 may be provided on the output side or input side of fourth voltage follower circuit 50d on wiring 91. The detection signals from first seat electrode 21 and second seat electrode 22 may be input into multiplexer 60. Moreover, wiring 91 is wiring that extends from the connection point of wiring 91a and wiring 91b to multiplexer 60.

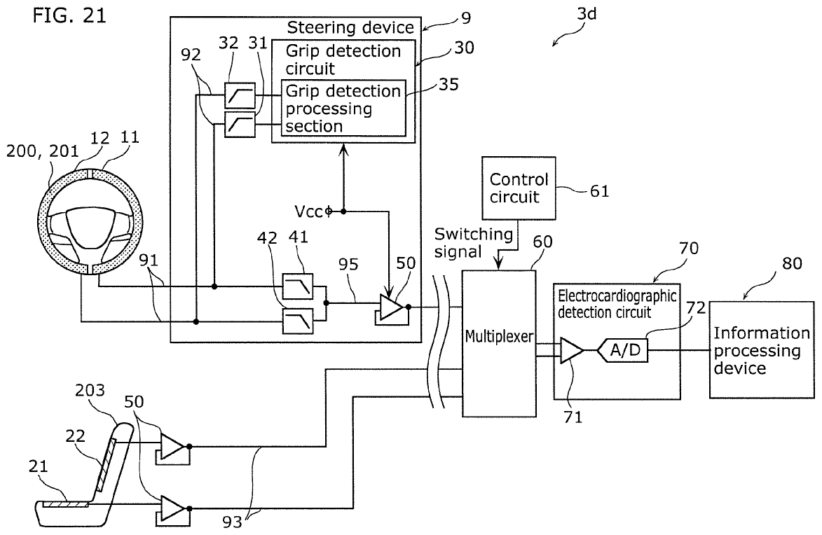

Moreover, the measurement device according to Embodiments 8 through 10 and the variation of Embodiment 8 may be measurement device 3d illustrated in FIG. 21. FIG. 21 is a block diagram of measurement device 3d according to a variation. Measurement device 3d illustrated in FIG. 21 has the same block diagram configuration as that of measurement device 1d illustrated in FIG. 19. Accordingly, detailed description thereof will be omitted.

Moreover, a program that realizes the measurement device according to Embodiments 1 through 10 and the variations of Embodiments 1, 4, and 8 may typically be implemented as an LSI circuit, which is an integrated circuit. Each of the processing units may be individually realized as a single chip, or a portion or all of the processing units may be realized as a single chip.

Moreover, circuit integration is not limited to LSI; the processing units may be realized as dedicated circuits or generic processors. A field programmable gate array (FPGA) that is programmable after manufacturing of the LSI circuit, or a reconfigurable processor whose connections and settings regarding circuit cells in the LSI circuit are reconfigurable, may be used.

Note that in Embodiments 1 through 10 and the variations of Embodiments 1, 4, and 8, each element may be configured in the form of dedicated hardware, or may be realized by executing a software program suitable for the element. Each element may be realized by means of a program executing unit, such as a CPU or processor, reading and executing the software program recorded on a recording medium such as a hard disk or a semiconductor memory.

Moreover, all of the numerical values presented above are examples for providing a detailed description. The numerical values according to the present disclosure are not limited to those exemplified in Embodiments 1 through 10 and the variations of Embodiments 1, 4, and 8.

The block diagrams illustrate one example of the division of functional blocks; a plurality of functional blocks may be realized as a single functional block, a single functional block may be broken up into a plurality of functional blocks, and part of one function may be transferred to another functional block. The functions of a plurality of functional blocks having similar functions may be processed by a single piece of hardware or software in parallel or by time-division.

The order in which the steps are executed in the flow charts are merely examples presented for illustrative purposes; the steps may be executed in a different order. Moreover, some of the steps may be executed at the same time as (in parallel with) other steps.

Embodiments arrived at by a person skilled in the art making various modifications to any one of Embodiments 1 through 10 and the variations of Embodiments 1, 4, and 8 as well as embodiments realized by arbitrarily combining elements and functions described in Embodiments 1 through 10 and the variations of Embodiments 1, 4, and 8 which do not depart from the spirit of the present disclosure are included within the scope of in the present disclosure.

Further Information about Technical Background to this Application

The disclosures of the following Japanese Patent Applications including specification, drawings and claims are incorporated herein by reference in their entirety: Japanese Patent Application No. 2019-155995 filed on Aug. 28, 2019, Japanese Patent Application No. 2019-155999 filed on Aug. 28, 2019, Japanese Patent Application No. 2019-156012 filed on Aug. 28, 2019, and Japanese Patent Application No. 2020-020413 filed on Feb. 10, 2020.

### INDUSTRIAL APPLICABILITY

The grip sensor according to the present disclosure is applicable to, for example, a steering wheel in a vehicle or the handlebars on a motorcycle.

1. A measurement device, comprising:
a first electrode provided on a steering wheel;
a second electrode provided on a front surface section of a driver's seat or on the steering wheel;
a grip detection circuit electrically connected to the first electrode via a first high pass filter; and
an electrocardiographic detection circuit electrically connected to at least the first electrode via a first low pass filter and electrically connected to the second electrode.

2. The measurement device according to claim 1,
wherein the second electrode is:
provided in a different location on the steering wheel than the first electrode;
electrically connected to the grip detection circuit via a second high pass filter different from the first high pass filter; and
electrically connected to the electrocardiographic detection circuit via a second low pass filter different from the first low pass filter.

3. The measurement device according to claim 2,
wherein the grip detection circuit outputs, independently of each other, a signal indicating a detection result according to a detection signal resulting from detection by the first electrode and a signal indicating a detection result according to a detection signal resulting from detection by the second electrode.

4. The measurement device according to claim 1, further comprising:
a first selector electrically connected to the first electrode, the first low pass filter, and the first high pass filter,
wherein the electrocardiographic detection circuit is electrically connected to the first electrode via the first low pass filter, and electrically connected to the second electrode, and
the first selector is configured to select the first low pass filter, and configured to select the first high pass filter.

5. The measurement device according to claim 4, further comprising:
a second selector electrically connected to the second electrode;
a second low pass filter electrically connected to the second selector, the second low pass filter being different from the first low pass filter; and
a second high pass filter electrically connected to the second selector, the second high pass filter being different from the first high pass filter,
wherein the electrocardiographic detection circuit is electrically connected to the first low pass filter and the second low pass filter,
the grip detection circuit is electrically connected to the first high pass filter and the second high pass filter,
the second electrode is provided in a different location on the steering wheel than the first electrode, and
the second selector is configured to select the second low pass filter, and configured to select the second high pass filter, in synchronization with the first selector.

6. The measurement device according to claim 5,
wherein when an amplitude of an electrocardiogram (ECG) waveform detected by the electrocardiographic detection circuit is less than a predetermined value, the first selector selects the first high pass filter for a predetermined period, and the second selector selects the second high pass filter for the predetermined period.

7. The measurement device according to claim 4,
wherein the first selector selects both the first low pass filter and the first high pass filter.

8. The measurement device according to claim 5,
wherein the second selector selects both the second low pass filter and the second high pass filter in synchronization with the first selector.

9. The measurement device according to claim 8,
wherein on a condition that a noise level of at least one of a detection signal input into the electrocardiographic detection circuit and a detection signal input into the grip detection circuit is greater than or equal to a predetermined noise level in a state in which both the first low pass filter and the first high pass filter are selected by the first selector and both the second low pass filter and the second high pass filter are selected by the second selector,
when an amplitude of an electrocardiogram (ECG) waveform detected by the electrocardiographic detection circuit is less than a predetermined value:
the first selector selects the first high pass filter for a predetermined period; and
the second selector selects the second high pass filter for the predetermined period.

10. The measurement device according to claim 5, further comprising:
a first voltage follower circuit electrically connected to the first low pass filter and the electrocardiographic detection circuit; and
a second voltage follower circuit electrically connected to the second low pass filter and the electrocardiographic detection circuit,
wherein a wiring distance from the first low pass filter to the first electrode is shorter than a wiring distance from the first low pass filter to the electrocardiographic detection circuit, and a wiring distance from the first voltage follower circuit to the first electrode is shorter than a wiring distance from the first voltage follower circuit to the electrocardiographic detection circuit, and
a wiring distance from the second low pass filter to the second electrode is shorter than a wiring distance from the second low pass filter to the electrocardiographic detection circuit, and a wiring distance from the second voltage follower circuit to the second electrode is shorter than a wiring distance from the second voltage follower circuit to the electrocardiographic detection circuit.

11. The measurement device according to claim 4,
wherein the second electrode is provided on the front surface section, and
the electrocardiographic detection circuit is electrically connected to the first low pass filter and the second electrode.

12. The measurement device according to claim 11,
wherein when an amplitude of an electrocardiogram (ECG) waveform detected by the electrocardiographic detection circuit is less than a predetermined value,
the first selector selects the first high pass filter for a predetermined period.

13. The measurement device according to claim 11, further comprising:
a third electrode provided in a different location on the steering wheel than the first electrode;
a second low pass filter electrically connected to the third electrode, the second low pass filter being different from the first low pass filter; and
a second selector electrically connected between a second high pass filter and the third electrode, and between the third electrode and the second low pass filter, the second high pass filter being different from the first high pass filter,
wherein the third electrode is electrically connected to the grip detection circuit via the second high pass filter,
an output of the first low pass filter and an output of the second low pass filter are combined and input into the electrocardiographic detection circuit, and
the second selector alternately selects the second low pass filter and the second high pass filter in synchronization with the first selector.

14. The measurement device according to claim 11, further comprising:
a first voltage follower circuit electrically connected to the first low pass filter and the electrocardiographic detection circuit,
wherein a wiring distance from the first low pass filter to the first electrode is shorter than a wiring distance from the first low pass filter to the electrocardiographic detection circuit, and a wiring distance from the first voltage follower circuit to the first electrode is shorter than a wiring distance from the first voltage follower circuit to the electrocardiographic detection circuit.

15. The measurement device according to claim 11, further comprising:
a third electrode provided in a different location on the steering wheel than the first electrode;
a second low pass filter electrically connected to the third electrode, the second low pass filter being different from the first low pass filter; and
a second selector electrically connected between a second high pass filter and the third electrode, and between the third electrode and the second low pass filter, the second high pass filter being different from the first high pass filter,
wherein the third electrode is electrically connected to the grip detection circuit via the second high pass filter,
a first voltage follower circuit electrically connected to the first low pass filter and the electrocardiographic detection circuit; and
a second voltage follower circuit electrically connected to the second low pass filter and the electrocardiographic detection circuit,
wherein a wiring distance from the first low pass filter to the first electrode is shorter than a wiring distance from the first low pass filter to the electrocardiographic detection circuit, and a wiring distance from the first voltage follower circuit to the first electrode is shorter than a wiring distance from the first voltage follower circuit to the electrocardiographic detection circuit, and
a wiring distance from the second low pass filter to the third electrode is shorter than a wiring distance from the second low pass filter to the electrocardiographic detection circuit, and a wiring distance from the second voltage follower circuit to the third electrode is shorter than a wiring distance from the second voltage follower circuit to the electrocardiographic detection circuit.

16. The measurement device according to claim 1, further comprising:
a control circuit electrically connected to the electrocardiographic detection circuit and the grip detection circuit,
wherein the control circuit outputs a normal grip signal when the electrocardiographic detection circuit detects an electrocardiogram (ECG) waveform and the grip detection circuit detects a grip.

17. The measurement device according to claim 16,
wherein the second electrode is:
provided in a different location on the steering wheel than the first electrode;
electrically connected to the grip detection circuit via a second high pass filter different from the first high pass filter; and
electrically connected to the electrocardiographic detection circuit via a second low pass filter different from the first low pass filter, and
the control circuit outputs the normal grip signal when the electrocardiographic detection circuit detects the ECG waveform and the grip detection circuit detects the grip.

18. The measurement device according to claim 17,
wherein the grip detection circuit outputs to the control circuit, independently of each other, a signal indicating a detection result according to a detection signal resulting from detection by the first electrode and a signal indicating a detection result according to a detection signal resulting from detection by the second electrode,
the control circuit outputs the normal grip signal when the grip detection circuit detects the grip via both the first electrode and the second electrode, and
the control circuit outputs an insufficient grip signal when the grip detection circuit detects the grip via only one of the first electrode and the second electrode.

19. The measurement device according to claim 16,
wherein the control circuit outputs an insufficient grip signal when an amplitude of the ECG waveform detected by the electrocardiographic detection circuit is less than a predetermined value.

20. The measurement device according to claim 16,
wherein the control circuit outputs an anomaly signal when the grip detection circuit detects the grip and the electrocardiographic detection circuit does not detect the ECG waveform.
